(19) United States
(12) Patent Application Publication
(10) Pub. No.: US 2012/0156599 A1
(43) Pub. Date: Jun. 21, 2012

(54) ELECTROPHOTOGRAPHIC PHOTOCONDUCTOR AND IMAGE FORMING APPARATUS INCLUDING THE SAME

(76) Inventors: Takatsugu Obata, Osaka (JP); Akihiro Kondoh, Osaka (JP)

(21) Appl. No.: 13/311,283

(22) Filed: Dec. 5, 2011

(30) Foreign Application Priority Data
Dec. 17, 2010 (JP) 2010-282049

(51) Int. Cl. G03G 15/00

(52) U.S. Cl. 430/56; 399/159; 430/58.85

(57) ABSTRACT

An electrophotographic photoconductor, comprising:

a conductive support; and

a photosensitive layer provided on the conductive support and containing a charge generation material and a charge transport material,

the photosensitive layer containing, as the charge transport material, a compound represented by the following general formula (I):

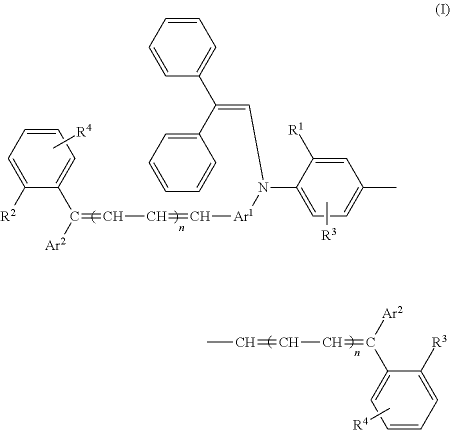

wherein Ar¹ represents an optionally substituted arylene or bivalent heterocyclic group; Ar²s, which may be the same or different, each represent a hydrogen atom or an optionally substituted alkyl, aralkyl, aryl or monovalent heterocyclic group; R1 represents an optionally substituted alkyl group; R²s each represent a hydrogen atom or an optionally substituted alkyl group; R³ and R⁴s, which may be the same or different, each represent a hydrogen atom or an optionally substituted alkyl or alkoxy group; and n is 0 or 1.

### CROSS-REFERENCE TO RELATED APPLICATION

This application is related to Japanese Patent Application No. 2010-282049 filed on 17 Dec. 2010, whose priority is claimed under 35 USC §119, and the disclosure of which is incorporated by reference in its entirety.

### BACKGROUND OF THE INVENTION

1. Field of the Invention

The present invention relates to an organic photoconductive material, and an electrophotographic photoconductor and an image forming apparatus with the use of the material.

2. Description of the Related Art

In recent years, organic photoconductive materials have been widely researched and developed to be used for electrostatic recording elements such as photoconductors. Besides, the organic photoconductive materials are beginning to be applied to sensing elements, organic electro luminescent (abbreviated as EL) elements, and the like.

Organic photoconductors with the use of the organic photoconductive materials have been progressively developed as a main force of photoconductors as being superior in film formation ability of a photosensitive layer, flexibility, lightness and transparency, and therefore advantageously allowing easy design of a photoconductor showing good sensitivity to a wider wavelength region by appropriate sensitization.

The organic photoconductors initially had disadvantages in sensitivity and durability, but these disadvantages have been significantly overcome by development of function separation type photoconductors in which a charge generation function and a charge transport function are independently assigned to separate materials. Besides, in addition to the advantages of the organic photoconductors, the function separation type photoconductors have an advantage in that they have a wide range of choices for materials for forming their photosensitive layers and photoconductors having optional characteristics can be produced relatively easily.

For the organic photoconductors, various structures have been proposed such as a monolayer structure in which a charge generation material and a charge transport material (also referred to as “charge transfer material”) are both dispersed in a binder resin on a support; and a multilayer structure or a reversed double-layered structure in which a charge generation layer obtained by dispersing a charge generation material in a binder resin and a charge transport layer obtained by dispersing a charge transport material in a binder resin are formed on a support in this order or in a reverse order. Out of them, function separation type photoconductors having a charge generation layer and a charge transport layer stacked thereon as a photosensitive layer have been in wide practical use, because they are superior in electrophotographic characteristics and durability, and have a higher degree of freedom in material selection to allow various designs for characteristics of the photoconductors.

As the charge generation material usable for the function separation type photoconductors, a variety of substances have been considered and various kinds of materials having strong light resistance and high charge generation ability have been proposed such as phthalocyanine pigments, squarylium dyes, azo pigments, perylene pigments, polycyclic quinone pigments, cyanine dyes, squaric acid dyes and pyrylium salt dyes.

As the charge transport material, various kinds of compounds are known such as pyrazoline compounds, hydrazone compounds, triphenylamine compounds, stilbene compounds and enamine compounds.

It is demanded that the photoconductors having the structures proposed or considered as described above should have various abilities such as higher speed, durability and sensitivity stability. In particular, it is demanded that the photoconductors should achieve both higher sensitivity to deal with the higher speed and more durability, that is, longer life by improvement in abrasion resistance and sensitivity stability as characteristics of the photoconductor to be compatible with reverse development type electrophotographic devices such as recent digital copying machines and laser printers. In addition, it is demanded that the photoconductors to be used for laser printers and the like should have higher image reliability and repeat stability.

Among others, the higher sensitivity has been achieved recently by development of enamine-based charge transport materials having higher mobility as disclosed in Japanese Unexamined Patent Publication No. 2000-112157 and Japanese Unexamined Patent Publication No. 2004-334125, for example.

However, these photoconductors generally have lower durability compared with inorganic photoconductors, which has been considered one of major disadvantages. The durability is broadly classified into electrophotographic physical durability in terms of sensitivity, residual potential, chargeability and image blurring; and mechanical durability in terms of abrasion or damage on surfaces of the photoconductors due to friction. It is known that reduction in the electrophotographic physical durability is mainly caused by ozone and NOx (nitrogen oxides) generated due to corona discharge, and degradation of the charge transport material contained in the surface layer of the photoconductors due to exposure to light. Many charge transport materials having various skeletons proposed so far have been considerably improved in durability, but the durability is not yet sufficient.

In addition, the photoconductors are used in systems repeatedly, during which they are required to constantly provide a certain level of stable electrophotographic characteristics. In fact, however, none of the structures so far have not provided sufficient stability or durability.

That is, the photoconductors undergo lowered potential, increased residual potential and sensitivity change to result in reduced copy quality and become unusable with repeated use. All the causes for such deterioration has not been clarified, but there are some possible factors.

For example, it has been revealed that oxidized gases such as ozone and nitrogen oxides discharged from a corona charger significantly damage the photosensitive layer. These oxidized gases chemically change materials in the photosensitive layer to cause various characteristic changes. For example, the charge potential is decreased, the residual potential is increased and the surface resistance is reduced to cause definition reduction. As a result, image blurring such as blank dots and black bars are generated on output images to significantly reduce the image quality and shorten the lifetime of the photoconductor. Against such a phenomenon, it has been proposed to take a measure for avoiding the direct influence of the gas on the photoconductor by efficiently exhausting and replacing the gas around the corona charger or proposed to prevent deterioration by adding an antioxidant and a stabilizer to the photosensitive layer.

For example, Japanese Unexamined Patent Publication No. SHO 62(1987)-105151 discloses that an antioxidant having a triazin ring and a hindered phenol skeleton in the molecule is added to a photosensitive layer, and Japanese Unexamined Patent Publication No. SHO 63(1988)-18355 discloses that a specific hindered amine is added to a photosensitive layer. In addition, Japanese Unexamined Patent Publication No. SHO 63(1988)-4238, Japanese Unexamined Patent Publication No. SHO 63(1988)-216055 and Japanese Unexamined Patent Publication No. HEI 3(1991)-172852 disclose that a trialkylamine or an aromatic amine is added to a photosensitive layer, and Japanese Unexamined Patent Publication No. HEI 5(1993)-158258 discloses that an amine dimer is added to a photosensitive layer. However, in most cases where an additive such as the above-mentioned antioxidants is added, the electric characteristics of the photoconductors are degraded.

That is, the conventional techniques have not achieved sufficient gas resistance effect yet, and there remain negative effects in practical use due to addition of such antioxidants such as degradation in electrophotographic characteristics including sensitivity and residual potential. It is therefore awaited that a novel material capable of enhancing the gas resistance and having no negative effect in terms of the electrophotographic characteristics is proposed.

### SUMMARY OF THE INVENTION

It is therefore an object of the present invention to provide a photoconductor having higher sensitivity, sufficient photoresponsivity and enhanced gas resistance, and an image forming apparatus including the photoconductor.

The inventors of the present invention have made intensive studies and efforts and, as a result, found that blank dots on output images are caused by surface resistance reduced due to gas such as NOx that is discharged from a corona charger and interacts with a charge transport material in a photosensitive layer to adhere to an outer layer, and that the degree of the blank dots is greatly affected by the structure of the charge transport material. The inventors of the present invention have therefore considered structures having less interactions with NOx and, as a result, found that it is effective to block an N atom in the structure of a charge transport material, that is, to introduce an alkyl group to the ortho position of a phenyl group in N-phenyl.

The introduction of an alkyl group to this position decreases conjugated systems to significantly reduce the mobility and deteriorate the responsiveness. However, the inventors of the present invention have found that the compound of the present invention having two stilbene or butadiene units has high sensitivity and sufficient photoresponsivity while maintaining excellent gas resistance.

Furthermore, the inventors of the present invention have newly found that the introduction of an alkyl group to the ortho position enhances abrasion resistance and that such characteristics are very useful in a photoconductor and an image forming apparatus including the photoconductor to reach completion of the present invention.

According to an aspect of the present invention, there is provided an electrophotographic photoconductor, comprising: a conductive support; and a photosensitive layer provided on the conductive support and containing a charge generation material and a charge transport material, the photosensitive layer containing, as the charge transport material, a compound represented by the general formula (I):

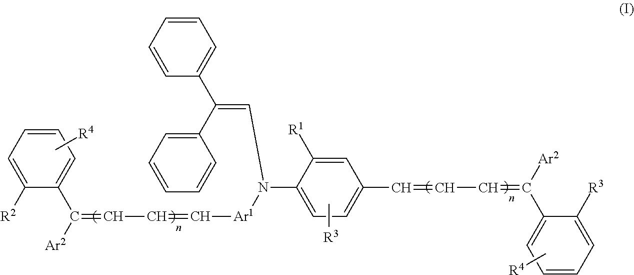

wherein Ar¹ represents an optionally substituted allylene or bivalent heterocyclic group; Ar²s, which may be the same or different, each represent a hydrogen atom or an optionally substituted alkyl, aralkyl, aryl or monovalent heterocyclic group; R¹ represents an optionally substituted alkyl group; R²s each represent a hydrogen atom or an optionally substituted alkyl group; R³ and R⁴s, which may be the same or different, each represent a hydrogen atom or an optionally substituted alkyl or alkoxy group; and n is 0 or 1.

According to another aspect of the present invention, there is provided the electrophotographic photoconductor, wherein the photosensitive layer contains, as the charge generation material, an oxotitaniumphthalocyanine having at least a diffraction peak in a diffraction spectrum with Cu-Kα characteristic X-rays (wavelength: 1.54 Å) at a Bragg angle (2θ±0.2°) of 27.2°.

According to another aspect of the present invention, there is provided the electrophotographic photoconductor, wherein the photosensitive layer is a multilayer photosensitive layer including a charge generation layer containing the charge generation material and a charge transport layer containing the charge transport material.

According to another aspect of the present invention, there is provided the electrophotographic photoconductor, wherein the photosensitive layer is a monolayer photosensitive layer containing the charge generation material and the charge transport material.

According to another aspect of the present invention, there is provided the electrophotographic photoconductor, further comprising an interlayer between the conductive support and the photosensitive layer.

According to another aspect of the present invention, there is provided an image forming apparatus, comprising: the electrophotographic photoconductor; charge means for charging the electrophotographic photoconductor; exposure means for exposing the electrophotographic photoconductor to form an electrostatic latent image; development means for developing the electrostatic latent image into a toner image; transfer means for transferring the toner image onto a medium; and fixing means for fixing the toner image onto the medium.

According to another aspect of the present invention, there is provided the image forming apparatus, wherein an image is formed by using a reverse development process.

It is possible to provide a photoconductor having enhanced gas resistance, high sensitivity and sufficient photoresponsivity by including an enamine compound of the present invention in the photosensitive layer as the charge transport material. It is therefore possible to provide a photoconductor having ozone resistance and enhanced durability and environmental stability by including the charge transport material of the present invention in the photosensitive layer of the photoconductor.

Having the enhanced gas resistance, in addition, the photoconductor of the present invention can provide high-quality images even when used in a high-speed electrophotographic process.

Use of a photoconductor of the present invention therefore allows formation of high-quality images having enhanced gas resistance even in repeated use over a long period of time.

In addition, since the photoconductor of the present invention can provide high-quality images even in a high-speed electrophotographic process, it is possible to increase the image formation speed in the image forming apparatus of the present invention.

Containing an oxotitaniumphthalocyanine having at least a clear diffraction peak in a diffraction spectrum with Cu-Kα characteristic X-rays (wavelength: 1.54 Å) at a Bragg angle (2θ±0.2°) of 27.2° as the charge generation material, the electrophotographic photosensitive layer of the present invention has high charge generation efficiency and charge injection efficiency.

The charge generation material absorbs light to generate a large quantity of charges and injects the generated charges into the charge transport material efficiently without accumulating the charges therein.

As described above, the photosensitive layer contains the charge transport material represented by the general formula (I) and having a high charge mobility as an organic photoconductive material. Accordingly, charges generated in the charge generation material by light absorption can be injected into the charge transport material efficiently and transported smoothly, and it is therefore possible to obtain a high-sensitivity and high-resolution electrophotographic photoconductor.

According to an embodiment of the present invention, the photosensitive layer has a multilayer structure including the charge generation layer containing the charge generation material and the charge transport layer containing the charge transport material. According to this embodiment, the charge generation function and the charge transport function are assigned to different layers, and therefore optimal materials can be selected independently for the charge generation function and the charge transport function. As a result, it is possible to provide an electrophotographic photoconductor having higher sensitivity, increased stability in repeated use and higher durability.

According to an aspect of the present invention, an interlayer is provided between the conductive support and the photosensitive layer to prevent injection of charges from the conductive support into the photosensitive layer and prevent reduction of the chargeability of the photosensitive layer. Accordingly, reduction of surface charges on a part other than the parts to be eliminated by exposure is limited to prevent generation of image defects such as fogging. In addition, the interlayer can cover defects on a surface of the conductive support to obtain a uniform surface, thereby enhancing the film formation ability of the photosensitive layer.

Further, the interlayer can prevent delamination of the photosensitive layer from the conductive support to enhance the adhesiveness between the conductive support and the photosensitive layer.

According to another aspect of the present invention, there is provided an image forming apparatus including the electrophotographic photoconductor.

Since the electrophotographic photoconductor of the present invention has enhanced gas resistance, high sensitivity and sufficient photoresponsivity, it is possible to obtain a highly reliable image forming apparatus capable of providing high-quality images under various environments.

### BRIEF DESCRIPTION OF THE DRAWINGS

FIG. 1 is a partial cross sectional plan view schematically illustrating a configuration of an electrophotographic photoconductor 1, which is Embodiment 1 of the electrophotographic photoconductor of the present invention;

FIG. 2 is a partial cross sectional plan view schematically illustrating a configuration of an electrophotographic photoconductor 2, which is Embodiment 2 of the electrophotographic photoconductor of the present invention;

FIG. 3 is a partial cross sectional plan view schematically illustrating a configuration of an electrophotographic photoconductor 3, which is Embodiment 3 of the electrophotographic photoconductor of the present invention; and

FIG. 4 is a side view of an arrangement schematically illustrating a configuration of an image forming apparatus 100, which is one embodiment of the image forming apparatus of the present invention.

### DESCRIPTION OF THE PREFERRED EMBODIMENTS

### [Organic Photoconductive Material]

The enamine compound contained in the electrophotographic photoconductor of the present invention as the charge transport material is a compound represented by the following general formula (I):

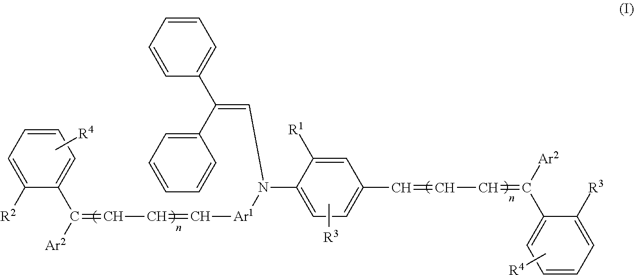

wherein Ar¹ represents an optionally substituted allylene or bivalent heterocyclic group; Ar²s, which may be the same or different, each represent a hydrogen atom or an optionally substituted alkyl, aralkyl, aryl or monovalent heterocyclic group; R¹ represents an optionally substituted alkyl group; R²s each represent a hydrogen atom or an optionally substituted alkyl group; R³ and R⁴s, which may be the same or different, each represent a hydrogen atom or an optionally substituted alkyl or alkoxy group; and n is 0 or 1.

Specifically, the compound of the general formula (I) include a compound represented by the following general formula (II):

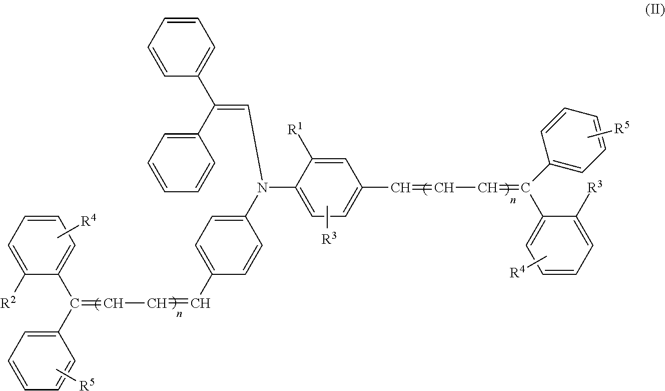

wherein R¹, R²s, R³, R⁴s and n are as defined in the general formula (I); and R⁵s each represent a hydrogen atom or an optionally substituted alkyl or alkoxy group.

Alternatively, the compound of the general formula (I) include a compound represented by the general formula (III):

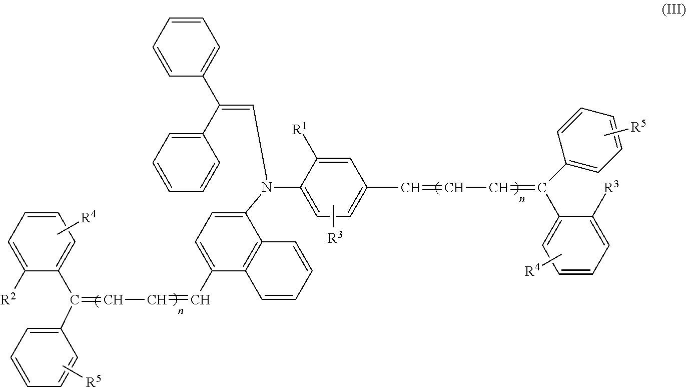

wherein R¹, R²s, R³, R⁴s, R⁵s and n are as defined in the general formula (I). In the general formula (I), Ar¹ represents an optionally substituted allylene or bivalent heterocyclic group.

Examples of the allylene group represented by Ar¹ include p-phenylene, m-phenylene, 1,4-naphthylene, 2,6-naphthylene, biphenylene, fluorenylene, stilbenzylene, 2-methyl-1,4-phenylene and 5,6,7,8-tetrahydro-1,4-naphthylene.

Examples of the bivalent heterocyclic group represented by Ar¹ include furylene, thienylene, thiazolylene, benzofurylene, phenylbenzofurylene and carbazolylene.

The allylene group and the divalent heterocyclic group optionally have one or more substituents.

Non-limiting examples of the substituents include linear or branched alkyl groups having 1 to 4 carbon atoms (which may be further substituted with one or more halogen atoms or alkoxy groups having 1 to 4 carbon atoms), linear or branched alkoxy groups having 1 to 4 carbon atoms (which may be further substituted with one or more halogen atoms or alkyl groups having 1 to 4 carbon atoms), halogen atoms (preferably fluorine atom), and phenoxy and phenylthio groups.

Specifically, in the general formula (I), Ar¹ represents an allylene group selected from the group consisting of phenylene, naphthylene, biphenylene, fluorenylene and stilbenzylene that may be substituted with a linear or branched C₁₋₄ alkyl, alkoxy or alkylene group or a phenoxy or phenylthio group that may be substituted with one or more halogen atoms or a linear or branched C₁₋₄ alkyl or alkoxy group; or a bivalent heterocyclic group selected from the group consisting of furylene, thienylene, thiazolylene, benzofurylene, phenylbenzofurylene and carbazolylene that may be substituted with a linear or branched C₁₋₄ alkyl, alkoxy or alkylene group or a phenoxy or phenylthio group that may be substituted with one or more halogen atoms or a linear or branched C₁₋₄ alkyl or alkoxy group.

More specifically, in the general formula (I), Ar¹ represents an allylene group selected from the group consisting of phenylene and naphthylene that may be substituted with one or more halogen atoms or a linear or branched C₁₋₄ alkyl, alkoxy or alkylene group; or a divalent heterocyclic group selected from the group consisting of furylene, thienylene and thiazolylene that may be substituted with one or more halogen atoms or a linear or branched C₁₋₄ alkyl, alkoxy or alkylene group.

Still more specifically, in the general formula (I), Ar¹ represents a group selected from the group consisting of 1,4-phenylene, 2-methyl- 1,4-phenylene, 5,6,7,8-tetrahydro-1,4-naphthylene and 1,4-naphthylene groups.

In the general formula (I), Ares each independently represent a hydrogen atom, or an optionally substituted alkyl, aralkyl, aryl, or monovalent heterocyclic group.

Examples of the alkyl group represented by each Ar² include methyl, ethyl, n-propyl, isopropyl, t-butyl, cyclohexyl and cyclopentyl groups.

Examples of the aralkyl group represented by each Ar² include benzyl, p-methoxybenzyl, phenethyl and 1-naphthylmethyl groups.

Examples of the aryl group represented by each Ar² include phenyl, tolyl, naphthyl, pyrenyl and biphenyl groups.

Examples of the monovalent heterocyclic group represented by each Ar² include furyl, thienyl, thiazolyl, benzofuryl, benzothiophenyl and benzothiazolyl.

The above-mentioned alkyl groups, aralkyl groups, aryl groups and monovalent heterocyclic groups optionally have one or more substituents.

Non-limiting examples of the substituents include an alkyl group having 1 to 4 carbon atoms that may be further substituted with one or more halogen atoms or an alkoxy group having 1 to 4 carbon atoms; an alkoxy group having 1 to 4 carbon atoms that may be further substituted with one or more halogen atoms or an alkyl group having 1 to 4 carbon atoms; a halogen atom (preferably fluorine atom); and phenyl, phenoxy and phenylthio groups.

Specifically, in the general formula (I), Ar²s, which may be the same or different, each represent a hydrogen atom; or an alkyl group selected from the group consisting of methyl, ethyl, n-propyl, isopropyl, t-butyl, cyclohexyl and cyclopentyl groups that may be substituted with a linear or branched C₁₋₄ alkyl or alkoxy group or a phenyl, phenoxy, phenylthio or naphthyl group that may be substituted with one or more halogen atoms or a linear or branched C₁₋₄ alkyl or alkoxy group. Alternatively, Ar²s, which may be the same or different, each represent a hydrogen atom; an aralkyl group selected from the group consisting of benzyl and phenethyl groups that may be substituted with a linear or branched C₁₋₄ alkyl or alkoxy group or a phenyl, phenoxy, phenylthio or naphthyl group that may be substituted with one or more halogen atoms or a linear or branched C₁₋₄ alkyl or alkoxy group; or a monovalent heterocyclic group selected from the group consisting of furyl, thienyl, thiazolyl, benzofuryl, benzothiophenyl and benzothiazolyl groups.

More specifically, in the general formula (I), Ar²s, which may be the same or different, each represent a hydrogen atom; or an alkyl group selected from the group consisting of methyl, ethyl, n-propyl, isopropyl and t-butyl groups that may be substituted with one or more halogen atoms, a linear or branched C₁₋₄ alkyl or alkoxy group or a phenyl, phenoxy or naphthyl group. Alternatively, Ar²s, which may be the same or different, each represent a hydrogen atom; or a monovalent heterocyclic group selected from the group consisting of furyl, thienyl and thiazolyl groups that may be substituted with one or more halogen atoms, a linear or branched C₁₋₄ alkyl or alkoxy group or a phenyl, phenoxy or naphthyl group.

Still more specifically, in the general formula (I), Ar²s, which may be the same or different, each represent a hydrogen atom; or a group selected from the group consisting of isopropyl, phenyl, benzyl and thienyl groups.

In the general formula (I), R¹ represents an optionally substituted C₁₋₄ alkyl group, and R²s each represent a hydrogen atom or an optionally substituted C₁₋₄ alkyl group.

Examples of the optionally substituted alkyl group represented by R1 include methyl, ethyl, propyl, isopropyl and trifluoromethyl groups.

Specifically, in the general formula (I), R¹ represents an alkyl group selected from the group consisting of methyl, ethyl, n-propyl, isopropyl, n-butyl and t-butyl groups that may be substituted with a halogen atom.

More specifically, in the general formula (I), R¹ represents an alkyl group selected from the group consisting of methyl, ethyl, n-propyl, isopropyl, n-butyl and t-butyl groups.

Still more specifically, in the general formula (I), R¹ represents a group selected from the group consisting of methyl, ethyl and isopropyl groups.

Examples of the optionally substituted alkyl group represented by R²s include methyl, ethyl, propyl, isopropyl and trifluoromethyl groups.

Specifically, in the general formula (I), R²s, which may be the same or different, each represent a hydrogen atom or an alkyl group selected from the group consisting of methyl, ethyl, n-propyl, isopropyl, n-butyl and t-butyl groups that may be substituted with a halogen atom.

More specifically, in the general formula (I), R²s, which may be the same or different, each represent a hydrogen atom or an alkyl group selected from the group consisting of methyl, ethyl, n-propyl, isopropyl, n-butyl and t-butyl groups.

Still more specifically, in the general formula (I), R²s, which may be the same or different, each represent a hydrogen atom, or a methyl or ethyl group.

R³ represents a hydrogen atom, or an optionally substituted alkyl or alkoxy group.

Examples of the optionally substituted alkyl group represented by R³ include methyl, ethyl, propyl, isopropyl and trifluoromethyl groups.

Examples of the optionally substituted alkoxy group represented by R³ include methoxy, ethoxy and isopropoxy groups.

Specifically, in the general formula (I), R³ represents a hydrogen atom or an alkyl group selected from the group consisting of methyl, ethyl, n-propyl, isopropyl, n-butyl and t-butyl groups that may be substituted with a halogen atom.

More specifically, in the general formula (I), R³ represents a hydrogen atom or an alkyl group selected from the group consisting of methyl, ethyl, n-propyl, isopropyl, n-butyl and t-butyl groups.

Still more specifically, in the general formula (I), R³ represents a hydrogen atom or a methyl group.

In the general formula (I), R⁴s, which may be the same or different, each represent a hydrogen atom or an optionally substituted alkyl or alkoxy group.

Examples of the optionally substituted alkyl group represented by each R⁴ include methyl, ethyl, propyl, isopropyl and trifluoromethyl groups.

Examples of the optionally substituted alkoxy group represented by each R⁴ include methoxy, ethoxy and isopropoxy groups.

Specifically, in the general formula (I), R⁴s each represent a hydrogen atom or an alkyl group selected from the group consisting of methyl, ethyl, n-propyl, isopropyl, n-butyl and t-butyl groups that may be substituted with a halogen atom. Alternatively, R⁴s each represent a hydrogen atom or an alkoxy group selected from the group consisting of methoxy, ethoxy, n-propoxy, isopropoxy, n-butoxy and t-butoxy groups that may be substituted with a halogen atom.

More specifically, in the general formula (I), R⁴s each represent a hydrogen atom or a group selected from the group consisting of methyl, ethyl, methoxy and ethoxy groups.

Still more specifically, in the general formula (I), R⁴s each represent a hydrogen atom or an o-methyl, p-methyl or p-methoxy group.

n is 0 or 1.

In present invention, the charge transport material represented by the general formula (I) and contained in the photosensitive layer can be prepared as described below, for example.

First, a diphenylacetaldehyde represented by the following formula (IV):

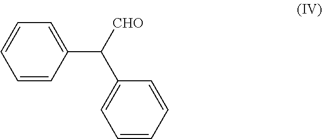

and a secondary amine compound represented by the following general formula (V):

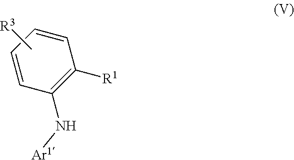

wherein Ar^{1′} is a precursor of Ar¹ in the general formula (I), and R¹ and R³ are as defined in the general formula (I) are subjected to a dehydration condensation reaction in a solvent to prepare an enamine compound represented by the following formula (VI):

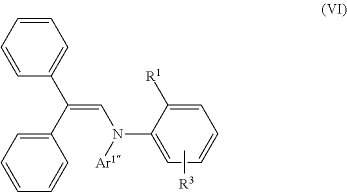

wherein Ar^{1″} is a precursor of Ar¹ in the general formula (I), and R¹ and R³ are as defined in the general formula (I).

This reaction is carried out by heating the diphenylacetaldehyde represented by the formula (IV) and an equivalent mol of the secondary amine compound represented by the formula (V) in the solvent in the presence of a catalyst.

Examples of the solvent to use in the reaction include non-polar solvents, alcohols, ethers and ketones, and specific examples thereof include toluene, xylene, chlorobenzene, butanol, diethylene glycol dimethyl ether and methyl isobutyl ketone.

Examples of the catalyst to use in the reaction include acid catalysts such as p-toluenesulfonic acid, camphor sulfonic acid and pyridinium-p-toluenesulfonic acid. The amount of the acid catalyst to use is 1/10 to 1/1000 mol equivalents, preferably 1/25 to 1/500 mol equivalents and more preferably 1/50 to 1/200 mol equivalents with respect to the amount of the diphenylacetaldehyde and the secondary amine compound as starting materials.

Since water generated as a byproduct in the reaction hinders the progress of the reaction, the condensation reaction is carried out in a reactor provided with a Dean-Stark, which heats the reaction system to the boiling point of the solvent to use or higher temperature to remove the generated water together with the solvent by azeotropic distillation. It is thereby possible to produce the enamine compound (VI) in high yield. Alternatively, in order to remove the generated water, a water adsorbent such as a molecular sieve may be added to the reaction system to carry out the condensation reaction.

Next, the enamine compound represented by the formula (VI) is subjected to a formylation reaction to prepare an enamine-aldehyde compound represented by the following general formula (VII):

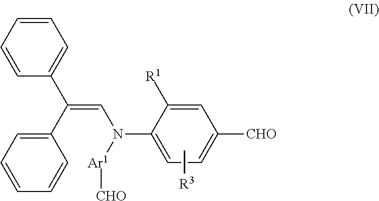

wherein Ar¹, R¹ and R³ are as defined in the general formula (I).

In this reaction, for example, 2.1 to 2.5 equivalents of a Vilsmeier reagent prepared with phosphorus oxychloride/N,N-dimethyl formaldehyde, phosphorus oxychloride/ N-methyl-N-phenyl formaldehyde or phosphorus oxychloride/N,N-diphenyl formaldehyde and 1.0 equivalent of the enamine compound represented by the formula (VI) in a solvent such as N,N-dimethyl formaldehyde and 1,2-dichloroethane are heated under stirring at 60° C. to 110° C. for 2 to 8 hours, and then subjected to hydrolysis with a 1 to 8 N aqueous solution of sodium hydroxide, potassium hydroxide, or the like to synthesize the compound.

Lastly, an Wittig-Horner reaction is performed, in which the aldehyde compound represented by the general formula (VII) and a Wittig reagent represented by the following general formula (VIII):

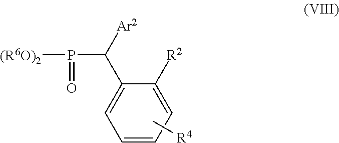

wherein Ar², R² and R⁴ are as defined in the general formula (1), and R⁶ represents an optionally substituted alkyl or aryl group, or (IX):

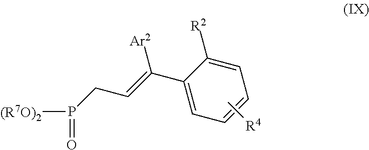

wherein Ar², R² and R⁴ are as defined in the general formula (1), and R⁷ represents an optionally substituted alkyl or aryl group are reacted under basic conditions to prepare the compound represented by the general formula (I) of the present invention.

When the Wittig reagent represented by the general formula (VIII) is used, it is possible to obtain an enamine compound represented by the general formula (I) having stilbene structures, wherein n is 0. When the Wittig reagent represented by the general formula (IX) is used, it is possible to obtain an enamine compound represented by the general formula (1) having butadiene structures, wherein n is 1.

The Wittig-Horner reaction is carried out as described below, for example.

A mixture of 1.0 equivalent of the aldehyde compound represented by the general formula (VII), 2.0 to 2.4 equivalents of the Wittig reagent represented by the general formula (VIII) or (IX) and 2.0 to 3.0 equivalents of a metal alkoxide in a suitable solvent is stirred at room temperature or a temperature of 30° C. to 60° C. for 2 to 8 hours to produce a charge transport material represented by the general formula (I) in high yield.

Examples of the solvent that may be used for the Wittig-Horner reaction include toluene, xylene, diethylether, tetrahydrofuran (THF), ethyleneglycol dimethylether, N,N -dimethylformamide and dimethylsulfoxide (DMSO).

Examples of the metal alkoxide include potassium t-butoxide, sodium ethoxide and sodium methoxide.

Specific examples of the charge transport material of the present invention represented by the general formula (I) include exemplary compounds having the respective groups shown in the following table. However, the organic photoconductive material of the present invention is not limited to the following exemplary compounds.

TABLE 1

| Compound | N—Ar¹ | Ar² | R¹ | R² | R³ | R⁴ | n |
|---|---|---|---|---|---|---|---|
| 1 | 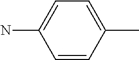 | H | CH₃ | H | H | H | 0 |
| 2 | 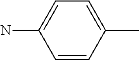 | H | CH₃ | CH₃ | H | H | 0 |
| 3 | 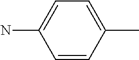 | H | CH₃ | CH₃ | H | o-CH₃ | 0 |
| 4 | 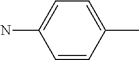 | H | CH₃ | CH₃ | H | p-CH₃ | 0 |
| 5 | 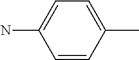 | H | CH₃ | CH₃ | H | p-OCH₃ | 0 |
| 6 | 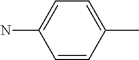 | H | CH₃ | H | 6-CH₃ | H | 0 |
| 7 | 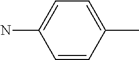 | H | C₂H₅ | H | H | H | 0 |
| 8 | 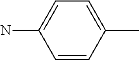 | H | iso-C₃H₇ | H | H | H | 0 |
| 9 | 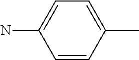 | H | CH₃ | C₂H₅ | H | H | 0 |
| 10 | 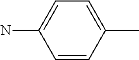 | 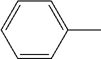 | CH₃ | H | H | H | 0 |
| 11 | 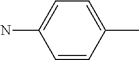 | 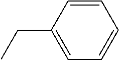 | CH₃ | CH₃ | H | H | 0 |
| 12 | 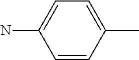 | iso-C₃H₇ | CH₃ | CH₃ | H | H | 0 |
| 13 | 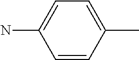 | 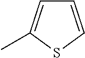 | CH₃ | H | H | H | 0 |
| 14 | 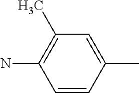 | H | CH₃ | H | H | H | 0 |
| 15 | 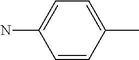 | H | CH₃ | CH₃ | H | H | 1 |
| 16 | 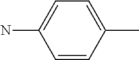 | H | CH₃ | CH₃ | H | p-CH₃ | 1 |
| 17 | 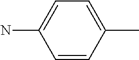 | H | CH₃ | CH₃ | H | p-OCH₃ | 1 |
| 18 | 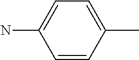 | 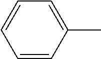 | CH₃ | H | H | H | 1 |
| 19 | 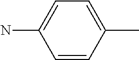 | 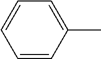 | CH₃ | CH₃ | H | p-CH₃ | 1 |
| 20 | 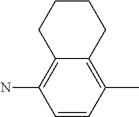 | H | CH₃ | H | H | H | 0 |
| 21 | 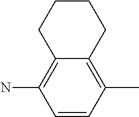 | 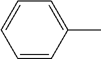 | CH₃ | H | H | H | 1 |
| 22 | 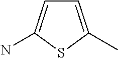 | H | CH₃ | CH₃ | H | p-CH₃ | 1 |
| 23 | 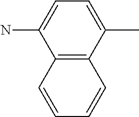 | H | CH₃ | H | H | H | 0 |
| 24 | 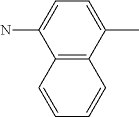 | H | CH₃ | CH₃ | H | H | 0 |
| 25 | 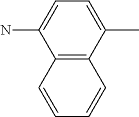 | H | CH₃ | CH₃ | H | o-CH₃ | 0 |
| 26 | 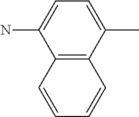 | H | CH₃ | CH₃ | H | p-CH₃ | 0 |
| 27 | 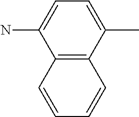 | H | CH₃ | CH₃ | H | p-OCH₃ | 0 |
| 28 | 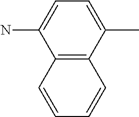 | H | CH₃ | H | 6-CH₃ | H | 0 |
| 29 | 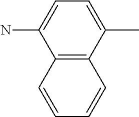 | H | C₂H₅ | H | H | H | 0 |
| 30 | 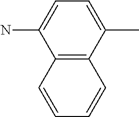 | H | iso-C₃H₇ | H | H | H | 0 |
| 31 | 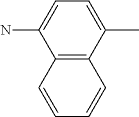 | H | CH₃ | C₂H₅ | H | H | 0 |
| 32 | 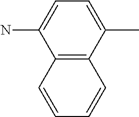 | 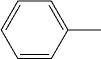 | CH₃ | H | H | H | 0 |
| 33 | 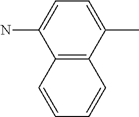 | 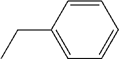 | CH₃ | CH₃ | H | H | 0 |
| 34 | 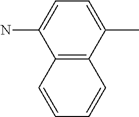 | iso-C₃H₇ | CH₃ | CH₃ | H | H | 0 |
| 35 | 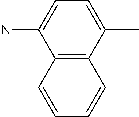 | 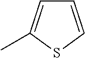 | CH₃ | H | H | H | 0 |
| 36 | 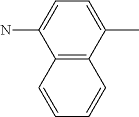 | H | CH₃ | H | H | H | 1 |
| 37 | 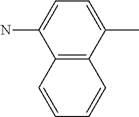 | H | CH₃ | CH₃ | H | H | 1 |
| 38 | 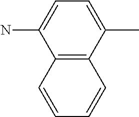 | H | CH₃ | CH₃ | H | p-CH₃ | 1 |
| 39 | 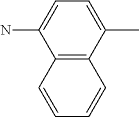 | H | CH₃ | CH₃ | H | p-OCH₃ | 1 |
| 40 | 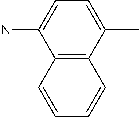 | 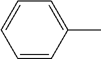 | CH₃ | H | H | H | 1 |
| 41 | 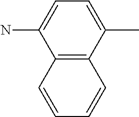 | 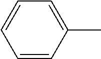 | CH₃ | CH₃ | H | p-CH₃ | 1 |

Out of the compounds represented by the general formula (I), Compounds 1, 4, 7, 10, 15, 18, 20, 23, 32 and 36 in Table 1 may be mentioned as compounds particularly superior as organic photoconductive materials in view of electric characteristics, costs and productivity, among which Compounds 1, 10, 23 and 36 are preferable.

### [Electrophotographic Photoconductor]

The electrophotographic photoconductor of the present invention is a multilayer type electrophotographic photoconductor or a monolayer type electrophotographic photoconductor in which a multilayer photosensitive layer formed of a charge generation layer containing a charge generation material and a charge transport layer containing a charge transport material stacked in this order or a monolayer photosensitive layer containing a charge generation material and a charge transport material is formed on a conductive support, and the charge transport layer or the monolayer photosensitive layer contains, as the charge transport material, a compound represented by the general formula (I), particularly Compound 1, 4, 7, 10, 15, 18, 20, 23, 32 or 36, or preferably Compound 1, 10, 23 or 36 shown in Table 1.

### Embodiments

Hereinafter, embodiments of the electrophotographic photoconductor and the image forming apparatus of the present invention will be described with reference to the attached drawings.

However, the electrophotographic photoconductor and the image forming apparatus of the present invention are not limited to the embodiments as described below, and any person skilled in the art will recognize from the description herein and the drawings attached hereto that the present invention covers various modifications, variations and changes which can be made to any of the embodiments without departing from the spirit and scope of the present invention.

### [Multilayer Type Electrophotographic Photoconductor]

### Embodiment 1

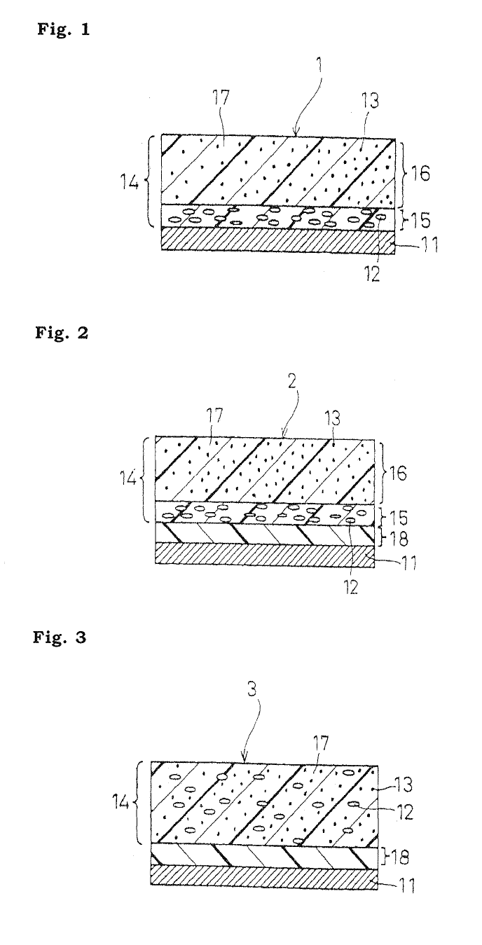

FIG. 1 is a partial cross sectional plan view schematically illustrating a configuration of an electrophotographic photoconductor 1, which is Embodiment 1 of the electrophotographic photoconductor of the present invention. In the present embodiment, the photosensitive layer has a multilayer structure including a charge generation layer and a charge transport layer.

The electrophotographic photoconductor 1 comprises: a sheet-like conductive support 11 formed of a conductive material; a charge generation layer 15 stacked on the conductive support 11 and containing a charge generation material 12; and a charge transport layer 16 stacked on the charge generation layer 15 and containing a charge transport material 13. The charge generation layer 15 and the charge transport layer 16 constitute a photoconductive layer being a photosensitive layer 14 of a multilayer type. In other words, the photoconductor 1 is a multilayer type photoconductor.

### <Conductive Support>

The conductive support 11 functions as an electrode of the photoconductor 1 and as a support member for the layers 15 and 16. The conductive support 11 is illustrated in the form of a sheet in the figure, but may be in the form of a cylinder, a drum or an endless belt, for example.

In the present invention, the conductive support may be any conductive support that can be used in a photoconductor. Examples of conductive materials usable for forming the conductive support 11 include a metal such as aluminum, copper, zinc and titanium; and alloys such as aluminum alloys and stainless steel.

The conductive materials are not limited to these metallic materials and may be materials obtained by laminating a metallic foil, vapor-depositing a metallic material, or vapor-depositing or applying a layer of a conductive compound such as conductive polymer, tin oxide and indium oxide on a surface of a polymeric material such as polyethylene terephthalate, nylon and polystyrene, or a substrate of hard paper, glass, or the like. These conductive materials can be formed into any shape suitable for conductive supports of photoconductors for use.

As needed, the surface of the conductive support 11 may be processed by anodic oxidation coating treatment, surface treatment using chemicals or hot water, coloring treatment, or irregular reflection treatment such as surface roughing to the extent that the image quality is not adversely affected. Since the wavelengths of laser light are uniform in an electrophotographic process with the use of a laser as an exposure light source, laser light reflected on the surface of the photoconductor may interfere with the laser light reflected on the inside of the photoconductor, resulting in appearance of interference fringes on an image and generation of an image defect. Such an image defect due to the interference by the laser beam having a uniform wavelength can be prevented by processing the surface of the conductive support 11 as described above.

### <Charge Generation Layer>

The charge generation layer 15 on the conductive support 11 contains the charge generation material 12 that absorbs light to generate charges.

### (Charge Generation Material)

Examples of the charge generation material include organic photoconductive materials and inorganic photoconductive materials. Examples of the organic photoconductive materials include azo pigments such as monoazo, bisazo and trisazo pigments; indigo pigments such as indigo and thioindigo; perylene pigments such as perylenimide and perylenic anhydride; polycyclic quinone pigments such as anthraquinone and pyrenequinone; phthalocyanine compounds such as metal phthalocyanines including oxotitaniumphthalocyanine compounds and metal-free phthalocyanines; squarylium dyes; pyrylium and thiopyrylium salts; and triphenylmethane dyes. Examples of the inorganic photoconductive materials include selenium and amorphous silicon.

These charge generation materials may be used independently, or two or more kinds may be used in combination.

Out of the above-mentioned charge generation materials, phthalocyanine compounds, in particular, oxotitaniumphthalocyanine compounds are preferably used.

The oxotitaniumphthalocyanine compounds used in the present invention mean oxotitaniumphthalocyanines and derivatives thereof. The derivatives of the oxotitaniumphthalocyanines include those in which a hydrogen atom on the aromatic ring of the phthalocyanine group is replaced with a halogen atom such as a chlorine or fluorine atom, a nitro group, a cyano group, a sulfonic acid group; and those in which the central metal of the oxotitaniumphthalocyanine, that is, a titanium atom, is coordinated with ligands such as chlorine atoms.

The oxotitaniumphthalocyanine compounds preferably have specific crystalline structures. Examples of such preferable oxotitaniumphthalocyanine compounds include those having crystalline structures showing at least a diffraction peak in an X-ray diffraction spectrum with Cu-Kα characteristic X-rays (wavelength: 1.54 Å) at a Bragg angle (2θ±0.2°) of 27.2°. Here, the Bragg angle 2θ means an angle between an incident X-ray and a diffracted X-ray, that is, so-called diffraction angle.

It is particularly preferable to use such an oxotitaniumphthalocyanine compound as a charge generation material in combination with the charge transport material represented by the general formula (1), because in such a case, the photoconductor can be further improved in gas resistance, sensitivity and resolution.

Having superior charge generation and charge injection abilities, the oxotitaniumphthalocyanine compounds can generate a large quantity of charges when absorbing light and then inject the charges into the charge transport layer 16 efficiently without accumulating the charges therein.

Meanwhile, since a compound represented by the general formula (I) and having higher charge mobility is used for the charge transport material 13, the charges generated by the charge generation material 12 upon light absorption can be efficiently injected into the charge transport material 13 to be smoothly transported. It is therefore possible to obtain an electrophotographic photoconductor further improved in sensitivity and resolution.

The oxotitaniumphthalocyanine compounds can be prepared by conventionally known preparation methods such as the method as described in Moser and Thomas, “Phthalocyanine Compounds”, Reinhold Publishing Corp., New York, 1963.

The oxotitaniumphthalocyanines can be prepared, for example, by heat-melting phthalonitrile and titanium tetrachloride, or heating and reacting them in a suitable solvent such as α-chloronaphthalene to synthesize dichlorotitanium-phthalocyanine, and then hydrolyzing it with a base or water. Alternatively, the oxotitaniumphthalocyanines can be prepared by heating and reacting isoindoline and titanium tetraalkoxide such as tetrabutoxy titanium in a suitable solvent such as N-methylpyrrolidone.

### (Sensitizer)

The charge generation material may be used in combination with a sensitizing dye (sensitizer). Addition of a sensitizer can improve the sensitivity of the photoconductor and suppress residual potential increase and charge potential decrease due to repeated use to enhance the electrical durability of the photoconductor.

Examples of the sensitizing dye include triphenylmethane dyes such as methyl violet, crystal violet, night blue and Victoria blue; acridine dyes such as erythrosine, rhodamine B, rhodamine 3R, acridine orange and flapeosine; thiazine dyes such as methylene blue and methylene green; oxazine dyes such as capri blue and meldola blue; cyanine dyes; styryl dyes; pyrylium salt dyes; and thiopyrylium salt dyes.

### (Binder Resin for Charge Generation Layer)

The charge generation layer 15 may contain a binder resin so as to enhance its binding ability.

Examples of the binder resin include resins such as polyester resins, polystyrene resins, polyurethane resins, phenol resins, alkyd resins, melamine resins, epoxy resins, silicone resins, acrylic resins, methacrylic resins, polycarbonate resins, polyarylate resins, phenoxy resins, polyvinyl butyral resins and polyvinyl formal resins; and copolymer resins containing two or more repeat units that form these resins.

Specific examples of the copolymer resins include insulating resins such as vinyl chloride-vinyl acetate copolymer resins, vinyl chloride-vinyl acetate-maleic anhydride copolymer resins and acrylonitrile-styrene copolymer resins.

The binder resin is not limited to the above-mentioned resins, and any resin generally used in the art may be used as the binder resin. The binder resins may be used independently, or two or more kinds may be used in combination.

The proportion of the charge generation material in the charge generation layer 15 is preferably 10% by weight or more and 99% by weight or less.

When the proportion of the charge generation material is less than 10% by weight, the sensitivity of the photoconductor may be reduced.

When the proportion of the charge generation material is more than 99% by weight, the film strength of the charge generation layer 15 may be reduced due to the too low binder resin content.

Besides, the dispersibility of the charge generation material in the charge generation layer 15 may decrease to increase coarse particles of the charge generation material, leading to increase in image defects, in particular, image fogging called black dots, that is, fine black dots of toner adhering onto a white background due to surface charges decreased by exposure in parts other than those to be eliminated.

A coating solution for charge generation layer formation can be prepared by, for example, dispersing the charge generation material and optionally a binder resin as described above in a suitable solvent by a conventionally known method.

### (Solvent for Coating Solution for Charge Generation Layer Formation)

Examples of the solvent to use in the coating solution for charge generation layer formation include halogenized hydrocarbons such as dichloromethane and dichloroethane; ketones such as acetone, methyl ethyl ketone and cyclohexanone; esters such as ethyl acetate and butyl acetate; ethers such as tetrahydrofuran and dioxane; alkyl ethers of ethylene glycol such as 1,2-dimethoxyethane; aromatic hydrocarbons such as benzene, toluene and xylene; and aprotic polar solvents such as N,N-dimethylformamide and N,N-dimethylacetamide.

These solvents may be used independently, or two or more kinds may be used in combination.

### (Coating Solution for Charge Generation Layer Formation)

The charge generation material may be milled in advance by use of a milling machine before being dispersed in the solvent. Examples of the milling machine include a ball mill, a sand mill, an attritor, an oscillation mill and an ultrasonic dispersing machine.

Examples of the dispersing machine to used for dispersing the charge generation material in the solvent include a paint shaker, a ball mill and a sand mill. On this occasion, dispersion conditions are appropriately set so as to prevent contamination of the solution with impurities generated due to abrasion or the like of materials forming the container and the dispersing machine to use.

### (Method for Forming Charge Generation Layer)

Examples of the method for forming the charge generation layer 15 include a vacuum deposition method in which the charge generation material is vacuum-deposited on the surface of the conductive support 11 and an application method in which the coating solution for charge generation layer formation containing the charge generation material is applied onto the surface of the conductive support 11. Out of them, the application method is preferably used as being simple.

Examples of the method for applying the coating solution for charge generation layer formation include a spraying method, a bar coating method, a roll coating method, a blade method, a ring method and a dipping coating method. Out of these methods for the application, the dipping coating method is relatively simple and advantageous in terms of productivity and costs, and therefore can be suitably used. In the dipping coating method, a substrate is immersed in a coating vessel filled with the coating solution, and then raised at a constant rate or at a rate that changes successively to form a layer on the surface of the substrate.

The apparatus to use for the dipping coating method may be provided with a coating solution dispersing machine typified by ultrasonic generators to stabilize the dispersibility of the coating solution. The method for the application is not limited to the above-mentioned methods, and an optimal method can be appropriately selected in consideration of physical properties of the coating solution and productivity.

The film thickness of the charge generation layer 15 is preferably in a range of 0.05 μm to 5 μm, more preferably in a range of 0.1 μm to 1 μm. The film thickness of the charge generation layer 15 of less than 0.05 μm may lead to reduction in the light absorption efficiency to reduce the sensitivity of the photoconductor 1. On the other hand, the film thickness of the charge generation layer 15 of more than 5 μm may cause transfer of charges in the charge generation layer 15 to be a rate-determining step in a process of eliminating charges on the surface of the photosensitive layer 14 to reduce the sensitivity of the photoconductor 1.

### <Charge Transport Layer>

The charge transport layer 16 contains the charge transport material 13 dispersed in a binder resin and has a function of transporting charges generated in the charge generation layer 15. As the charge transport material 13, the charge transport materials of the present invention represented by the general formulae (I), (II) and (III) may be used independently, or two or more kinds may be used in combination. As a result, it is possible to obtain a photoconductor having enhanced gas resistance, high sensitivity and sufficient photoresponsivity.

The compound represented by the general formula (I) may be used in combination with an additional charge transport material.

Examples of the additional charge transport material include carbazole derivatives, oxazole derivatives, oxadiazole derivatives, thiazole derivatives, thiadiazole derivatives, triazole derivatives, imidazole derivatives, imidazolone derivatives, imidazolidine derivatives, bisimidazolidine derivatives, styryl compounds, hydrazone compounds, polycyclic aromatic compounds, indole derivatives, pyrazoline derivatives, oxazolone derivatives, benzimidazole derivatives, quinazoline derivatives, benzofuran derivatives, acridine derivatives, phenazine derivatives, aminostilbene derivatives, triarylamine derivatives, triarylmethane derivatives, phenylenediamine derivatives, stilbene derivatives, and benzidine derivatives.

The examples further include polymers having groups derived from these compounds on the main chain or side chain such as poly-N-vinylcarbazole, poly-1-vinylpyrene, and poly-9-vinylanthracene.

### (Binder Resin for Coating Solution for Charge Transport Layer Formation)

As a binder resin 17 for forming the charge transport layer 16, a resin having excellent compatibility with the charge transport material 13 is selected.

Specific examples of such a binder resin include vinyl polymer resins such as polymethyl methacrylate resins, polystyrene resins and polyvinyl chloride resins, and copolymers comprising two or more repeat units that form the above-mentioned polymers, and polycarbonate resins, polyester resins, polyester carbonate resins, polysulfone resins, phenoxy resins, epoxy resins, silicone resins, polyarylate resins, polyamide resins, polyether resins, polyurethane resins, polyacrylamide resins and phenolic resins. In addition, heat-curable resins obtained by partially cross-linking the above-mentioned resins may be used.

These resins may be used independently, or two or more kinds may be used in combination.

Out of the above-mentioned resins, polystyrene resins, polycarbonate resins, polyarylate resins and polyphenylene oxides are preferably used, because they are superior in coatability, potential characteristics, and the like as well as in electric insulation, having a volume resistance of 10¹³ Ωcm or more.

In the charge transport layer 16, the ratio (B/A) of the weight (B) of the binder resin to the weight (A) of the charge transport material is preferably in a range of 1.2 to 3.0.

When the charge transport layer 16 contains a high proportion of the binder resin so that the ratio B/A is 1.2 or more, the charge transport layer 16 can be enhanced in printing durability.

When a conventional charge transport material is used with such a high proportion of the binder resin, the photoresponsivity of the photoconductor may be insufficient due to the decreased amount of the charge transport material.

In contrast, the photoconductor 1 can exhibit sufficiently high photoresponsivity and provides high-quality images even when the charge transport layer 16 contains a high proportion of the binder resin so that the ratio B/A is 1.2 or more, because the compound of the present invention represented by the general formula (1) has superior charge transport ability.

That is, the use of the compound of the present invention represented by the general formula (1) as a charge transport material allows the photoconductor 1 to be improved in printing durability of the charge transport layer 16 and in mechanical durability without deteriorating in photoresponsivity.

However, when the ratio B/A is more than 3.0, the proportion of the binder resin may be so high that the sensitivity of the photoconductor 1 may be reduced.

In addition, when the charge transport layer 16 is formed by a dipping coating method, the viscosity of the coating solution may increase to decrease the coating speed and the productivity may be significantly reduced. When the amount of the solvent in the coating solution is increased in order to restrict increase in the viscosity of the coating solution, a brushing phenomenon occurs and the charge transport layer 16 formed may become cloudy.

When the ratio B/A is less than 1.2, the proportion of the binder resin may be so low that the printing durability of the charge transport layer 16 may be reduced to increase the abrasion of the photosensitive layer 14 and decrease the chargeability of the photoconductor 1.

### (Additive for Charge Transport Layer)

As needed, the charge transport layer 16 may contain an additive such as a plasticizer and a leveling agent in order to improve film formation ability, flexibility, and surface smoothness. Examples of the plasticizer include dibasic acid esters such as phthalate esters, fatty acid esters, phosphoric esters, chlorinated paraffins and epoxy type plasticizers.

Examples of the leveling agent include silicone leveling agents such as dimethyl silicone, diphenyl silicone and phenylmethyl silicone.

In addition, the charge transport layer 16 may contain fine particles of an inorganic compound and/or an organic compound in order to improve mechanical strength and electric characteristics. Specific examples of the inorganic compound fine particles include fine particles of a metal oxide such as titanium oxide. Specific examples of the organic compound fine particles include fine particles of a fluorine-containing polymer such as tetrafluoro ethylene polymer fine particles.

The charge transport layer 16 may contain other various additives such as an antioxidant and a sensitizer as needed. Such additives can improve the potential characteristic, enhance the stability of the coating solution, reduce fatigue deterioration when the photoconductor is used repeatedly, and improve the durability.

As the antioxidant, a hindered phenol derivative, a hindered amine derivative or a benzylamine derivative is suitably used. The hindered phenol derivative, the hindered amine derivative and the benzylamine derivative may be mixed at any desired ratio.

Preferably, the amount of the hindered phenol derivative, the hindered amine derivative or the benzylamine derivative to use, or the total amount of the amount of the hindered phenol derivative, the hindered amine derivative and the benzylamine derivative to use is in a range of 0.1% by weight to 50% by weight with respect to the amount of the charge transport material 13.

When this amount is 0.1% by weight or more, the stability of the coating solution and the durability of the photoconductor can be improved more effectively. When the amount is more than 50% by weight, the characteristics of the photoconductor may be adversely affected.

### (Solvent for Coating Solution for Charge Transport Layer Formation)

Examples of the solvent to use for the coating solution for charge transport layer formation include aromatic hydrocarbons such as benzene, toluene, xylene, and monochlorobenzene; halogenated hydrocarbons such as dichloromethane and dichloroethane; ethers such as THF, dioxane, and dimethoxymethyl ether; and aprotic polar solvents such as N,N-dimethylformamide.

These solvents may be used independently, or two or more kinds may be used in combination.

As needed, a solvent such as alcohols, acetonitrile and methyl ethyl ketone may be further added to the solvent.

### (Method for Forming Charge Transport Layer)

As in the case of the formation of the charge generation layer 15, for example, the charge transport layer 16 is formed by dissolving or dispersing the charge transport material 13 and the binder resin 17 and, as needed, an additive as mentioned above in an appropriate solvent to prepare a coating solution for charge transport layer formation, and applying the coating solution onto the charge generation layer 15 by a spraying method, a bar coating method, a roll coating method, a blade method, a ring method, a dipping coating method, or the like. Out of these methods for the application, in particular, the dipping coating method is often used for the formation of the charge transport layer 16, because it is advantageous in various points as described above.

The film thickness of the charge transport layer 16 is preferably in a range of 5 μm to 50 μm, more preferably in a range of 10 μm to 40 μm.

The film thickness of the charge transport layer 16 of less than 5 μm may lead to deterioration in charge retention ability on the surface of the photoconductor. The film thickness of the charge transport layer 16 of more than 50μ may lead to decrease in resolution of the photoconductor 1.

### (Sensitizer for Charge Transport Layer)

Each layer in the photosensitive layer 14, that is, the charge generation layer 15 and/or the charge transport layer 16 may contain one or more electron acceptor substances and sensitizers such as dyes to the extent that the preferable properties according to the present invention are not deteriorated.

The addition of a sensitizer can increase the sensitivity of the photoconductor, and inhibit the residual potential increase and the fatigue due to repeated use to improve the electrical durability.

Examples of the electron acceptor substances include electron attractive materials such as acid anhydrides including succinic anhydride, maleic anhydride, phthalic anhydride and 4-chloronaphthalic acid anhydride; cyano compounds including tetracyanoethylene and terephthalmalondinitrile; aldehydes including 4-nitrobenzaldehyde; anthraquinones including anthraquinone and 1-nitroanthraquinone; polycyclic or heterocyclic nitro compounds including 2,4,7-trinitrofluorenone and 2,4,5,7-tetranitrofluorenone; and diphenoquinone compounds. In addition, may be used materials obtained by polymerizing these electron attractive materials.

Examples of the sensitizers such as dyes include xanthene type dyes, thiazine dyes, triphenylmethane dyes, quinoline type pigments, and organic photoconductive compounds such as copper phthalocyanine. These organic photoconductive compounds function as an optical sensitizer.

In the present embodiment, the photosensitive layer 14 has a multilayer structure in which the charge generation layer 15 and the charge transport layer 16 formed as described above are stacked. Since the materials for forming each layer can be independently selected by assigning a charge generation function and a charge transport function to separate layers, it is possible to select optimal materials for each of the charge generation function and the charge transport function. The photoconductor 1 is therefore particularly superior in electric characteristics such as chargeability, sensitivity and photoresponsivity, and in electrical and mechanical durability.

### Embodiment 2

FIG. 2 is a partial cross sectional plan view schematically illustrating a configuration of an electrophotographic photoconductor 2, which is Embodiment 2 of the electrophotographic photoconductor of the present invention. The electrophotographic photoconductor 2 of the present embodiment resembles the electrophotographic photoconductor 1 of Embodiment 1 illustrated in FIG. 1, and corresponding components will be denoted by the same reference numerals and description thereof will be omitted.

### <Interlayer>

It should be noted that the electrophotographic photoconductor 2 is provided with an interlayer 18 between the conductive support 11 and the photosensitive layer 14.

When the interlayer 18 is not provided between the conductive support 11 and the photosensitive layer 14, charges may be injected from the conductive support 11 to the photosensitive layer 14, and thus the chargeability of the photosensitive layer 14 may decrease to cause surface charge decrease in parts not exposed and generate an image defect including image fogging. In image formation by a reverse development process, in particular, a toner image is formed by toner adhering onto the parts having surface charges decreased by exposure to light. Then, when the surface charges are decreased by any other reasons than the exposure to light, image fogging called black dots, that is, fine black dots of toner adhering onto a white background may occur to significantly deteriorate the image quality.

In the photoconductor 2, the interlayer 18 is provided between the conductive support 11 and the photosensitive layer 14 as described above to prevent injection of charges from the conductive support 11 to the photosensitive layer 14. Accordingly, it is possible to prevent decrease in the chargeability of the photosensitive layer 14, inhibit surface charge decrease in the parts not exposed to light, and prevent occurrence of defects such as image fogging.

In addition, the interlayer 18 can cover defects on the surface of the conductive support 11 to obtain a uniform surface, thereby enhancing the film formation ability of the photosensitive layer 14.

Further, the interlayer 18 can act as an adhesive for the adhesion of the photosensitive layer 14 to the conductive support 11 and therefore inhibit delamination of the photosensitive layer 14 from the conductive support 11.

When the interlayer 18 is provided between the conductive support 11 and the photosensitive layer 14 in a conventional photoconductor, the sensitivity of the photoconductor may decrease. In the photoconductor 2, however, the photosensitive layer 14 contains the charge transport material of the present invention having superior charge transport ability, and therefore the interposition of the interlayer 18 does not decrease the sensitivity. That is, according to the present invention, the interlayer can be provided without decreasing the sensitivity of the photoconductor.

### (Resin Material for Interlayer)

The interlayer 18 may be a resin layer formed of various resin materials, an alumite layer, or the like. Examples of the resin materials for forming the resin layer include synthetic resins such as polyethylene resins, polypropylene resins, polystyrene resins, acrylic resins, polyvinyl chloride resins, polyvinyl acetate resins, polyurethane resins, epoxy resins, polyester resins, melamine resins, silicone resins, polyvinyl butyral resins and polyamide resins; and copolymer resins including two or more repeat units that form the above-mentioned synthetic resins. In addition, may be mentioned casein, gelatin, polyvinyl alcohols and ethyl celluloses.

Out of these resins, polyamide resins are preferably, and alcohol-soluble nylon resins are particularly preferable. Examples of the preferable alcohol-soluble nylon resins include so-called copolyamides obtained by copolymerizing 6-nylon, 6,6-nylon, 6,10-nylon, 11-nylon, 12-nylon, and the like; and resins obtained by chemically modifying nylon such as N-alkoxymethyl-modified nylon and N-alkoxyethyl-modified nylon.

### (Additive for Interlayer)

The interlayer 18 may contain particles such as metal oxide particles. The particles contained in the interlayer 18 can adjust the volume resistance of the interlayer and enhance the effect of the interlayer 18 to prevent injection of charges from the conductive support 11 to the photosensitive layer 14. In addition, the particles contained in the interlayer 18 can help maintenance of the electric characteristics of the photoconductor 2 under various environments to enhance the environmental stability. Examples of the metal oxide particles include titanium oxide, aluminum oxide, aluminum hydroxide and tin oxide particles.

The interlayer 18 can be formed, for example, by dissolving or dispersing the above-mentioned resin in an appropriate solvent to prepare a coating solution for interlayer formation and applying the coating solution onto the surface of the conductive support 11. For forming the interlayer 18 containing the metal oxide particles as described above, the particles are dispersed in the resin solution obtained by dissolving the resin in the appropriate solvent to prepare the coating solution for interlayer formation and the coating solution is applied onto the surface of the conductive support 11.

### (Solvent for Coating Solution for Interlayer Formation)

Examples of the solvent for the coating solution for interlayer formation include water, various organic solvents and mixture thereof. Out of them, it is preferable to use a single solvent such as water, methanol, ethanol and butanol; and a mixed solvent such as a combination of water and an alcohol, two or more kinds of alcohols, a combination of acetone or dioxolane and an alcohol, a combination of a chlorine-containing solvent such as dichloroethane, chloroform and trichloroethane and an alcohol.

### (Method for Forming Interlayer)

The metal oxide particles can be dispersed in the resin solution by any dispersion method known in the art such as those with the use of a ball mill, a sand mill, an attritor, an oscillation mill, an ultrasonic disperser, a paint shaker, or the like.

In the coating solution for interlayer formation, the ratio (C/D) of the total weight (C) of the resin and the metal oxide to the weight (D) of the solvent used in the coating solution for interlayer formation is preferably 1/99 to 40/60 and more preferably 2/98 to 30/70.

The ratio (E/F) of the weight (E) of the resin to the weight (F) of the metal oxide is preferably 90/10 to 1/99 and more preferably 70/30 to 5/95.

Examples of the method for applying the coating solution for interlayer formation include a spraying method, a bar coating method, a roll coating method, a blade method, a ring method and a dipping coating method. In particular, the dipping coating method is relatively simple and advantageous in terms of productivity and costs as described above, and therefore suitably used for the formation of the interlayer.

The film thickness of the interlayer 18 is preferably in a range of 0.01 μm to 20 μm and more preferably in a range of 0.05 μm to 10 μm. When the film thickness of the interlayer 18 is less than 0.01 μm, the film does not substantially function as the interlayer 18, and therefore a uniform surface by covering defects of the conductive support 11 cannot be achieved to fail in sufficiently preventing carrier injection from the conductive support 11 to the photosensitive layer 14 and deterioration of the photosensitive layer 14 in the chargeability.

It is not preferable that the film thickness of the interlayer 18 is more than 20 μm, because in this case, it is difficult to form the interlayer by dipping coating and to form the photosensitive layer 14 uniformly on the interlayer, which may result in reduction in the sensitivity of the photoconductor 2.

In the present embodiment, the charge transport layer 16 may contain an optional additive such as a plasticizer, a leveling agent, and fine particles of an inorganic compound and/or an organic compound as in the case of Embodiment 1. In addition, the charge generation layer 15 and/or the charge transport layer 16 in the photosensitive layer 14 may contain an additive such as an electron acceptor substance, a sensitizer including a dye, an antioxidant and an ultraviolet absorber.

### Embodiment 3

### [Monolayer Type Electrophotographic Photoconductor]

FIG. 3 is a partial cross sectional plan view schematically illustrating a configuration of an electrophotographic photoconductor 3, which is Embodiment 3 of the electrophotographic photoconductor of the present invention. The electrophotographic photoconductor 3 of the present embodiment resembles the electrophotographic photoconductor 2 of Embodiment 2 illustrated in FIG. 2, and corresponding components will be denoted by the same reference numerals and description thereof will be omitted.

It should be noted that the photosensitive layer 14 in the electrophotographic photoconductor 3 has a monolayer structure consisting of a single layer containing both the charge generation material and the charge transport material. In other words, the photoconductor 3 is a monolayer type photoconductor.

The monolayer type photoconductor 3 of the present embodiment is suitable for a positively-charged image forming apparatus generating less ozone. In addition, since the photosensitive layer 14 to apply is formed as a single layer, the photoconductor 3 is superior in production costs and yield rate to the multilayer type photoconductors 1 and 2 of Embodiments 1 and 2.

The photosensitive layer 14 can be formed by binding the compound represented by the general formula (I), (II) or (III), in particular, Compound 1, 4, 7, 10, 15, 18, 20, 23, 32 or 36 as the charge transport material and the above-described charge generation material with a binder resin. As the binder resin, any of the exemplary binder resins mentioned as the binder resin for the charge transport layer 16 in Embodiment 1 may be used.

The photosensitive layer 14 may contain various additives such as a plasticizer, a leveling agent, fine particles of an inorganic compound and/or an organic compounds, an electron acceptor substance, a sensitizer including a dye, an antioxidant, and an ultraviolet absorber, as in the case of the photosensitive layer 14 in Embodiment 1.

The photosensitive layer 14 can be formed in the same manner as in the charge transport layer 16 in the photoconductor 1 of Embodiment 1. The photosensitive layer 14 can be formed by, for example, dissolving or dispersing appropriate amounts of the charge generation material, the charge transport material of the present invention represented by the general formula (I) and the binder resin, and appropriate amounts of an optional charge transport material other than the charge transport material of the present invention and an optional additive in an appropriate solvent as described above for the coating solution for charge transport layer formation in Embodiment 1 to prepare a coating solution for photosensitive layer formation, and applying the coating solution for photosensitive layer formation onto the interlayer 18 by a dipping coating method, or the like.

The ratio (B′/A′) of the weight (B′) of the binder resin to the weight (A′) of the charge transport material in the photosensitive layer 14 is preferably 1.2 to 3.0, as in the case of the ratio B/A of the weight (B) of the binder resin to the weight (A) of the charge transport material in the charge transport layer 16 in Embodiment 1. The proportion of the charge generation material in the photosensitive layer 14 is preferably in a range of 1.5% by weight to 10% by weight.

The film thickness of the photosensitive layer 14 is preferably 5 μm to 100 μm and more preferably 10 μm to 50 μm. When the film thickness of the photosensitive layer 14 is less than 5 μm, the charge retention ability of the surface of the photoconductor may be reduced. When the film thickness of the photosensitive layer 14 is more than 100 μm, the productivity may be reduced.

In the photoconductor 3 of Embodiment 3, the photosensitive layer 14 can contain a higher proportion of the binder resin, because the compound of the present invention represented by the general formula (1) and having high charge transport ability is used as the charge transport material. Accordingly, the photoconductor 3 can be improved in printing durability of the charge transport layer 16 and in mechanical durability without reducing the photoresponsivity.

The electrophotographic photoconductor of the present invention is not limited to the configurations of the electrophotographic photoconductors 1, 2 and 3 of Embodiments 1, 2 and 3 as described above, and may be provided in any other configurations or arrangements as long as the photosensitive layer contains the compound of the present invention represented by the general formula (1) as the charge transport material.

### (Surface Protective Layer)

For example, a surface protective layer may be provided on a surface of the photosensitive layer 14 according to any of

Embodiments 1 to 3. The surface protective layer provided on the photosensitive layer can further improve the mechanical durability of the photoconductor.

The surface protective layer may be a layer formed of a resin, an inorganic filler-containing resin or an inorganic oxide, for example.

### Embodiment 4

### [Image Forming Apparatus]

The image forming apparatus of the present invention comprises the electrophotographic photoconductor of the present invention.

Comprising the electrophotographic photoconductor that has high charge potential, high sensitivity, sufficient photoresponsivity and superior durability, and does not deteriorate in such properties even when used under low temperature environments or in a high-speed process, the image forming apparatus is highly reliable so that it can provide high-quality images under various environments.

The image forming apparatus of the present invention can be any of various types of printers, copying machines, facsimile machines, printers, and multifunctional systems, monochrome or color imaging, that use an electrophotographic process.

Hereinafter, an embodiment of the image forming apparatus including the electrophotographic photoconductor of the present invention will be described. The image forming apparatus of the present invention is not limited to the following description.

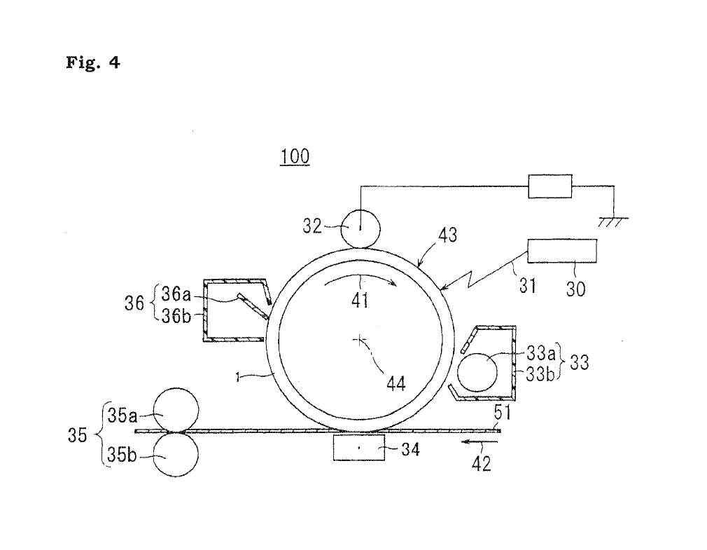

FIG. 4 is a side view of an arrangement schematically illustrating a configuration of an image forming apparatus 100, which is one embodiment of the image forming apparatus of the present invention. The image forming apparatus 100 illustrated in FIG. 4 comprises the photoconductor 1, which is Embodiment 1 of the electrophotographic photoconductor of the present invention. Hereinafter, the configuration and the mode of image forming operation of the image forming apparatus 100 will be described with reference to FIG. 4.

The image forming apparatus 100 comprises the photoconductor 1 freely-rotatably supported on an apparatus body, not shown, and driving means, not shown, for driving the photoconductor 1 to rotate around a rotation axis 44 in a direction of an arrow 41. The driving means comprises a source of power such as a motor, from which the power is transmitted to the support constituting a core of the photoconductor 1 via gears, not shown, thereby to derive the photoconductor 1 to rotate at a predetermined peripheral velocity Vp (hereinafter, the peripheral velocity Vp may be also referred to as rotational peripheral velocity Vp).

Along the circumferential surface of the photoconductor 1, a charger 32, an exposure unit 30, a developing unit 33, a transfer unit 34 and a cleaner 36 are provided in this order from an upstream side toward a downstream side in the rotational direction of the photoconductor 1 indicated by the arrow 41.

The charger 32 is means for charging a surface 43 of the photoconductor 1 at a given potential.

While the charger 32 is illustrated as a contact type charger such as a charge roller in FIG. 4, the charger 32 is not limited thereto and may be a non-contact type charger such as a corona charger (for example, scorotron charger).

The exposure unit 30 comprises a light source such as a semiconductor laser, and the light source emits light 31 such as laser beam according to image information to expose the charged surface 43 of the photoconductor 1 to light, thereby forming an electrostatic latent image corresponding to the image information on the surface 43 of the photoconductor 1.

The developing unit 33 is means for developing the electrostatic latent image formed on the surface 43 of the photoconductor 1 with a developer (for example, toner) to form a visible toner image. The developing unit 33 is provided so as to face the photoconductor 1. The developing unit 33 comprises, for example, a developing roller 33a for supplying the developer onto the surface 43 of the photoconductor 1, and a casing 33b for supporting the developing roller 33a so that the roller is rotatable around a rotation axis parallel to the rotation axis 44 of the photoconductor 1 and containing the developer.

The transfer unit 34 is means for transferring the toner image formed on the surface 43 of the photoconductor 1 onto a recording paper 51 as a medium receiving the transfer. In FIG. 4, the transfer unit 34 is non-contact type transfer means that includes charge means such as a corona discharger and transfers a toner image onto the recording paper 51 by giving the recording paper 51 charges of a polarity reverse to that of the toner. However, the transfer unit 34 may be contact type transfer means using pressure to perform the transfer. For example, the contact type transfer means may comprise a transfer roller for pressing the recording paper 51 against the photoconductor 1 from the side not contacting the surface 43 of the photoconductor 1, during which, a voltage is applied to the transfer roller to transfer the toner image onto the recording paper 51.

The cleaner 36 is means for cleaning the surface of the photoconductor 1 after the image transfer. For example, the cleaner 36 may comprise a cleaning blade 36a to be pressed against the surface 43 of the photoconductor 1 so as to scrape off residual toner on the surface 43 after the image transfer by the transfer unit 34, and a collection casing 36b for containing the developer scraped off by the cleaning blade 36a.

The cleaner 36 is provided along with a discharger, not shown. The discharger is means for removing residual charges on the surface of the photoconductor 1. The discharger may be a discharge lamp, for example.

At a side toward which the recording paper 51 passing between the photoconductor 1 and the transfer unit 34 is conveyed, provided is a fixing unit 35, which is fixing means for fixing the toner image transferred. The fixing unit 35 comprises a heat roller 35a having heating means, not shown, and a pressure roller 35b provided opposite the heat roller 35a so as to be pressed by the heat roller 35a to form an abutment.

Hereinafter, the mode of image forming operation of the image forming apparatus 100 will be described.

First, in response to a direction from a control unit, not shown, the photoconductor 1 is driven by the driving means to rotate in the direction of the arrow 41, and then the surface 43 is uniformly charged to a predetermined positive or negative potential by the charger 32 provided at an upstream side of the rotation direction of the photoconductor 1 with respect to an image formation point of the light 31 from the exposure unit 30.

Then, in response to a direction from the control unit, the light 31 is emitted from the exposure unit 30 to the charged surface 43 of the photoconductor 1. The light 31 from the light source is repeatedly passed for scanning in a main scanning direction, that is, the longitudinal direction of the photoconductor 1 according to the image information. The scanning with the light 31 from the light source is repeated according to the image information while the photoconductor 1 is being driven to rotate thereby to expose the surface 43 of the photoconductor 1 to the light 31 according to the image information. The surface charge in parts exposed to the light 31 is reduced to generate a difference between the surface potential in the parts exposed to the light 31 and the surface potential in the parts not exposed to the light 31. As a result, an electrostatic latent image is formed on the surface 43 of the photoconductor 1.

In synchronization with the exposure for the photoconductor 1, the recording paper 51 is fed from a direction of an arrow 42 to a transfer position between the transfer unit 34 and the photoconductor 1 by transport means.

Subsequently, the toner is supplied onto the surface 43 of the photoconductor 1, on which the electrostatic latent image has been formed, from the developing roller 33a of the developing unit 33 provided at a downstream side of the rotation direction of the photoconductor 1 with respect to the image formation point of the light 31 from the light source. Thereby, the electrostatic latent image is developed into a visible toner image on the surface 43 of the photoconductor 1. When being fed between the photoconductor 1 and the transfer unit 34, the recording paper 51 is charged to a polarity reverse to the polarity of the toner by the transfer unit 34 thereby to transfer the toner image formed on the surface 43 of the photoconductor 1 onto the recording paper 51.

The recording paper 51 on which the toner image has been transferred is transported to the fixing unit 35 by the transport means, and heated and pressurized when passing through the abutment between the heat roller 35a and the pressure roller 35b of the fixing unit 35. As a result, the toner image is fixed onto the recording paper 51 to be a solid image. The recording paper 51 on which the image has been thus formed is ejected to the outside of the image forming apparatus 100 by the transport means.

In the meantime, as the photoconductor 1 further rotates in the direction of the arrow 41 after the toner image is transferred onto the recording paper 51, the cleaning blade 36a of the cleaner unit 36 scrapes and cleans the surface 43. After the residual toner is removed from the surface 43 of the photoconductor 1, light from the discharge lamp eliminates the charge on the surface 43 to eliminate the electrostatic latent image on the surface 43 of the photoconductor 1. Thereafter, the photoconductor 1 is further driven to rotate, and a series of operations beginning with the charge of the photoconductor 1 is repeated again. As described above, images are formed successively.

In the electrophotographic photoconductor 1 included in the image forming apparatus 100, the photosensitive layer 14 contains the compound of the present invention represented by the general formula (1) as the charge transport material, and therefore the photoconductor 1 is superior in electric characteristics such as chargeability, sensitivity and photoresponsivity; electrical and mechanical durability; and environmental stability. As a result, it is possible to achieve the image forming apparatus 100, which is highly reliable as being capable of steadily forming high-quality images for a long term under various environments.

In addition, even when the photoconductor 1 is used in a high-speed electrophotographic process, the image quality is not deteriorated. Accordingly, the image formation speed of the image forming apparatus 100 can be increased. For example, it is possible to form high-quality images even when the photoconductor 1 having a diameter of 30 mm and a longitudinal length of 340 mm is used in a high-speed electrophotographic process at a rotational peripheral velocity Vp of the photoconductor 1 of approximately 100 to 140 mm/ second, and the image forming apparatus 100 is operated at a high image formation speed of 25 sheets of A4 paper per minute according to JIS P0138.

The image forming apparatus of the present invention is not limited to the configuration described above with reference to FIG. 4, and may be in any other configurations, as long as it comprises a photoconductor of the present invention.

### EXAMPLES

Hereinafter, the present invention will be described in detail with reference to production examples, examples and comparative examples; however, the present invention is not limited to these examples at all.

### Production Example 1

### Production of Compound 1

O-triphenylamine (18.3 g, 1.0 mole equivalent), diphenylacetaldehyde (20.6 g, 1.05 mole equivalents) and DL-10-camphor sulfonic acid (0.23 g, 0.01 mole equivalents) were added to 300 mL of toluene in a reactor equipped with a Dean-Stark. Then, the mixture was refluxed under heating to be reacted for 6 hours, while water azeotroped with toluene was being removed. After completion of the reaction, the reaction solution was concentrated until the volume was reduced to about 1/10 and gradually added dropwise to 100 mL of hexane under vigorous stirring. The crystals generated were filtered off, washed with cold ethanol and recrystallized in a mixed solvent of toluene and ethyl acetate (1:3) to obtain 28.6 g (yield: 79%) of crystals of an enamine compound (X) represented by the following formula (X):

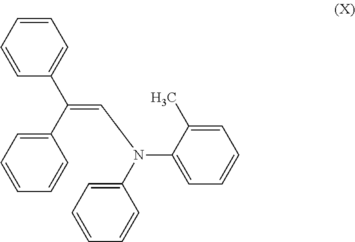

The resulting compound was confirmed to be an enamine compound represented by the formula (X), because the compound was analyzed by liquid chromatography-mass spectrometry (abbreviated as LC-MS) to observe a peak corresponding to a molecular ion [M]+ of the target enamine compound (X) (calculated molecular weight: 361.18) at 361.3. In addition, the analysis by the LC-MS revealed that the purity of the enamine compound (X) obtained was 98.9%.

Next, 16.9 g (2.2 mole equivalents) of phosphorus oxychloride was gradually added to 200 ml of anhydrous N,N-dimethylformamide (DMF) under ice cooling and stirred for approximately 30 minutes to prepare a Vilsmeier reagent. To the Vilsmeier reagent, 36.1 g (1.0 mole equivalent) of the enamine compound was gradually added under ice cooling. Thereafter, the mixture was gradually heated up to 80° C. and stirred for 6 hours while being kept at 80° C. to 90° C. for reaction. After completion of the reaction, the reaction solution was allowed to cool and gradually added to 800 ml of cooled 4N aqueous sodium hydroxide to form a precipitate. The precipitate formed was filtered, sufficiently washed with water, and then recrystallized with a mixed solvent of ethanol and ethyl acetate to obtain 16.9 g of a yellow powdered compound (yield: 81%).

The compound obtained was analyzed by LC-MS to observe a peak corresponding to a molecular ion [M]+ of an enamine-aldehyde intermediate (calculated molecular weight: 417.17) represented by the following formula (XI) at 417.3 and therefore find that the compound was an enamine-aldehyde intermediate represented by the formula (XI).

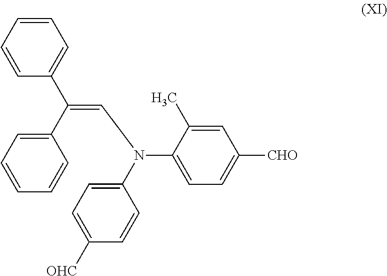

In addition, the analysis by the LC-MS revealed that the purity of the enamine-aldehyde intermediate obtained was 97.7%.

Then, 8.34 g (1.0 mole equivalent) of the aldehyde compound obtained as described above and 10.04 g (2.2 mole equivalents) of a Wittig reagent represented by the following formula (XII) were dissolved in 80 mL of anhydrous DMF.

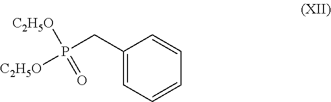

Then, 1.29 g (2.3 mole equivalents) of potassium t-butoxide was gradually added to the solution under cooing at 0° C.

After stirring for 1 hour at room temperature, the reaction solution was heated up to 40° C. and further stirred for 7 hours while being kept at 40° C. The reaction solution was allowed to cool, and then poured into an excess of methanol. A deposit was collected and dissolved in toluene to obtain a toluene solution. The toluene solution was moved to a separatory funnel to be washed with water, and then an organic layer was taken out to be dried with magnesium sulfate. The organic layer was then filtered to remove solid matters, and the filtrate was concentrated and subjected to silica gel column chromatography to obtain 8.03 g of a yellow crystal (yield: 71%).

The compound obtained was analyzed by LC-MS to observe a peak corresponding to a molecular ion [M]+ at 565.5 and therefore confirm that the compound was Compound 1 (calculated molecular weight: 565.28). In addition, the analysis by the LC-MS revealed that the purity of the compound obtained was 99.1%.

### Production Examples 2 to 10

Exemplary Compounds 4, 7, 10, 15, 18, 20, 23, 32 and 36 were each synthesized from corresponding materials via enamine compounds and enamine-aldehyde intermediates in the same manner as in Production Example 1. Table 2 shows the yield of each compound, and the purity and the molecular ion [M]+ of each final compound according to the LC-MS.

TABLE 2

| | | | | LC-MS | |
|---|---|---|---|---|---|
| | | | | | [M]+ |
| | | | | | (Calcu- |
| | Com- | | Yield | Purity | lated |
| | pound | Structure | (%) | (%) | value) |
| Production Example 1 | Com- pound 1 | 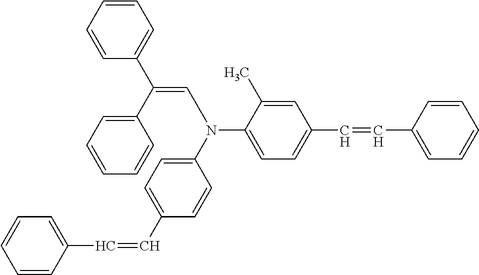 | 71 | 99.1 | 565.5 (565.28) |
| Production Example 2 | Com- pound 4 | 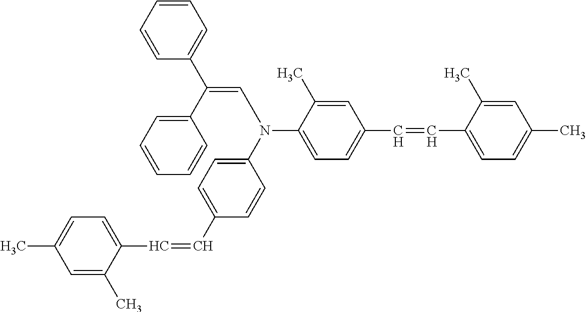 | 69 | 99.5 | 621.6 (621.34) |
| Production Example 3 | Com- pound 7 | 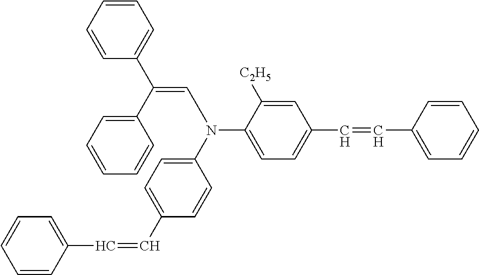 | 68 | 98.9 | 579.5 (579.29) |
| Production Example 4 | Com- pound 10 | 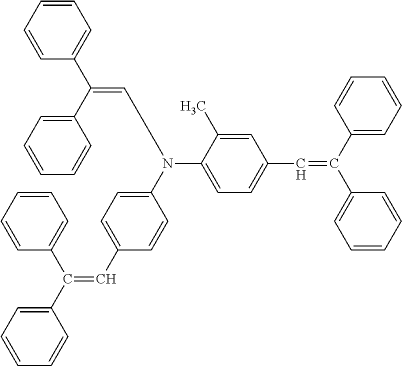 | 70 | 99.1 | 717.5 (717.34) |
| Production Example 5 | Com- pound 15 | 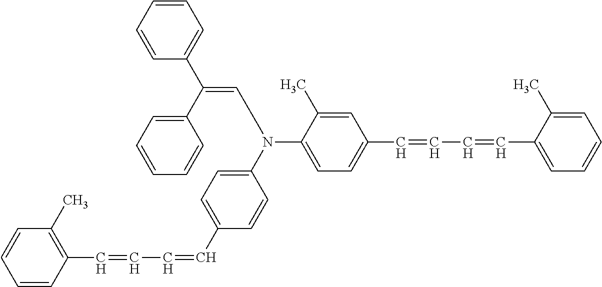 | 72 | 98.5 | 645.6 (645.34) |
| Production Example 6 | Com- pound 18 | 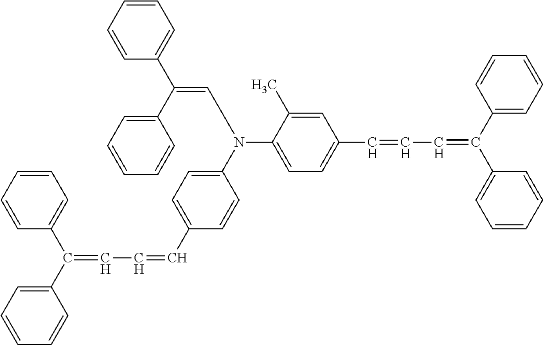 | 74 | 99.2 | 769.6 (769.37) |
| Production Example 7 | Com- pound 20 | 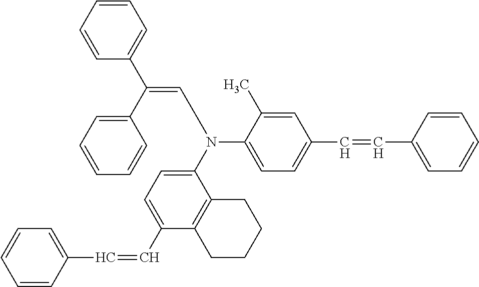 | 68 | 98.3 | 619.5 (619.32) |
| Production Example 8 | Com- pound 23 | 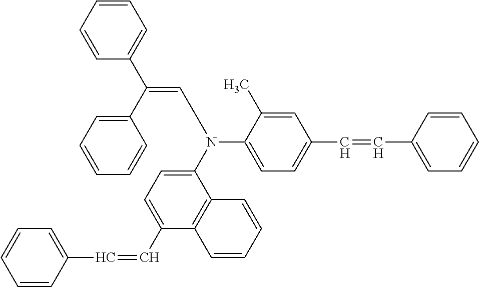 | 75 | 99.8 | 615.4 (615.29) |
| Production Example 9 | Com- pound 32 | 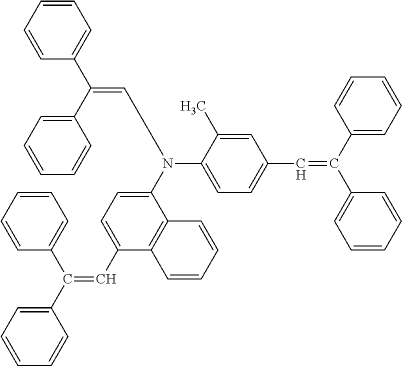 | 70 | 98.9 | 767.6 (767.36) |
| Production Example 10 | Com- pound 36 | 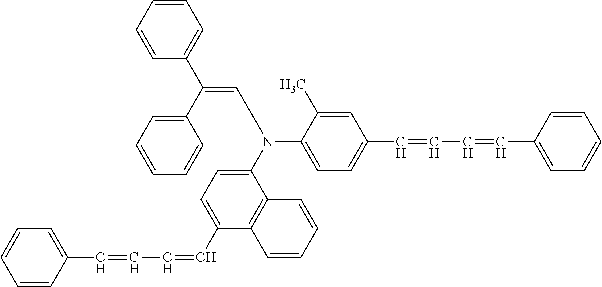 | 71 | 99.1 | 667.5 (667.32) |

### Example 1

Into a mixed solvent of 41 parts by weigh of 1,3-dioxolane and 41 parts by weight of methanol, 9 parts by weight of dendritic particles of titanium oxide surface-treated with aluminum oxide (Al₂O₃) and zirconium dioxide (ZrO₂) (TTO-D-1, product by Ishihara Sangyo Kaisha, Ltd.) and 9 parts by weight of copolymer nylon resin (CM8000, product by Toray Industries, Inc.) were added and dispersed by using a paint shaker for 8 hours to prepare a coating solution for interlayer formation (100 g). A cylindrical aluminum conductive support having a diameter of 30 mm and a longitudinal length of 357 mm was dipped in and withdrawn from a coating vessel filled with the coating solution for interlayer formation, and then dried to form an interlayer having a film thickness of 1.0 μm on the conductive support.

Then, 2 parts by weight of an oxotitaniumphthalocyanine having a crystal structure showing at least a diffraction peak in an X-ray diffraction spectrum with Cu-Kα characteristic X-rays (wavelength: 1.54 Å) at a Bragg angle (2θ±0.2°) of 27.2° as a charge generation material and 1 part by weight of polyvinyl butyral resin (S-LEC BM-S, product by Sekisui Chemical Co., Ltd.) were mixed with and dispersed in 97 parts by weight of methylethyl ketone by using a paint shaker to prepare a coating solution for charge generation layer formation (100 g). This coating solution for charge generation layer formation was applied onto the interlayer formed earlier by the same dipping coating method as in the case of the interlayer formation and dried to form a charge generation layer having a film thickness of 0.4 μm.

Next, 10 parts by weight of Compound 1 shown in Table 1 as a charge transport material, 20 parts by weight of polycarbonate resin (IUPILON Z400, product by Mitsubishi Engineering-Plastics Corporation) as a binder resin, 1 part by weight of 2,6-di-t-butyl-4-methylphenol and 0.004 parts by weight of dimethylpolysiloxane (KF-96, product by Shin-Etsu Chemical Co., Ltd.) were dissolved in 110 parts by weight of tetrahydrofuran (THF) to prepare a coating solution for charge transport layer formation (100 g). This coating solution for charge transport layer formation was applied onto the charge generation layer formed earlier by the same dipping coating method as in the case of the interlayer formation and dried at a temperature of 110° C. for 1 hour to form a charge transport layer having a film thickness of 25 μm.

Thus, an electrophotographic photoconductor of Example 1 was produced.

### Example 2

An electrophotographic photoconductor of Example 2 was produced in the same manner as in Example 1, except that Compound 4 shown in Table 1 was used instead of Compound 1 as a charge transport material.

### Example 3

An electrophotographic photoconductor of Example 3 was produced in the same manner as in Example 1, except that Compound 7 shown in Table 1 was used instead of Compound 1 as a charge transport material.

### Example 4

An electrophotographic photoconductor of Example 4 was produced in the same manner as in Example 1, except that Compound 10 shown in Table 1 was used instead of Compound 1 as a charge transport material.

### Example 5

An electrophotographic photoconductor of Example 5 was produced in the same manner as in Example 1, except that Compound 15 shown in Table 1 was used instead of Compound 1 as a charge transport material.

### Example 6

An electrophotographic photoconductor of Example 6 was produced in the same manner as in Example 1, except that Compound 18 shown in Table 1 was used instead of Compound 1 as a charge transport material.

### Example 7

An electrophotographic photoconductor of Example 7 was produced in the same manner as in Example 1, except that Compound 20 shown in Table 1 was used instead of Compound 1 as a charge transport material.

### Example 8

An electrophotographic photoconductor of Example 8 was produced in the same manner as in Example 1, except that Compound 23 shown in Table 1 was used instead of Compound 1 as a charge transport material.

### Example 9

An electrophotographic photoconductor of Example 9 was produced in the same manner as in Example 1, except that Compound 32 shown in Table 1 was used instead of Compound 1 as a charge transport material.

### Example 10

An electrophotographic photoconductor of Example 10 was produced in the same manner as in Example 1, except that Compound 36 shown in Table 1 was used instead of Compound 1 as a charge transport material.

### Comparative Example 1

An electrophotographic photoconductor of Comparative Example 1 was produced in the same manner as in Example 1, except that Comparative Compound A represented by the following structural formula (A) (structure of Compound 1 without o-methyl group) was used instead of Compound 1 as a charge transport material.

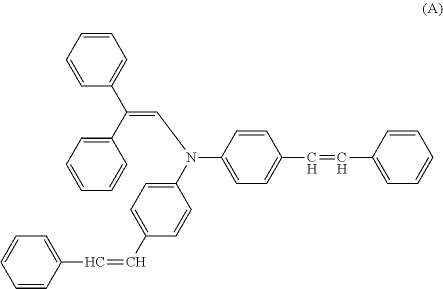

### Comparative Example 2

An electrophotographic photoconductor of Comparative Example 2 was produced in the same manner as in Example 1, except that Comparative Compound B represented by the following structural formula (B) (structure of Compound 15 without o-methyl group) was used instead of Compound 1 as a charge transport material.

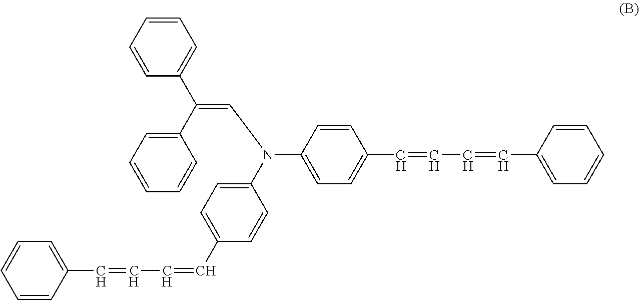

### Comparative Example 3

An electrophotographic photoconductor of Comparative Example 3 was produced in the same manner as in Example 1, except that Comparative Compound C represented by the following structural formula (C) (structure of Compound 32 without o-methyl group) was used instead of Compound 1 as a charge transport material.

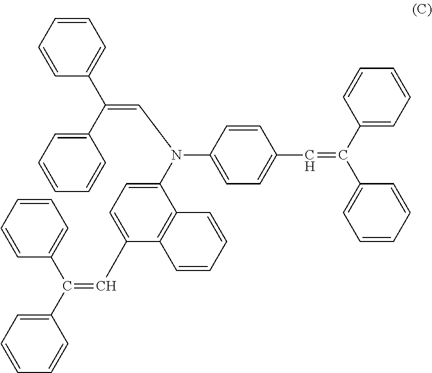

### Comparative Example 4

An electrophotographic photoconductor of Comparative Example 4 was produced in the same manner as in Example 1, except that Comparative Compound D represented by the following structural formula (D) (structure of Compound 36 without o-methyl group) was used instead of Compound 1 as a charge transport material.

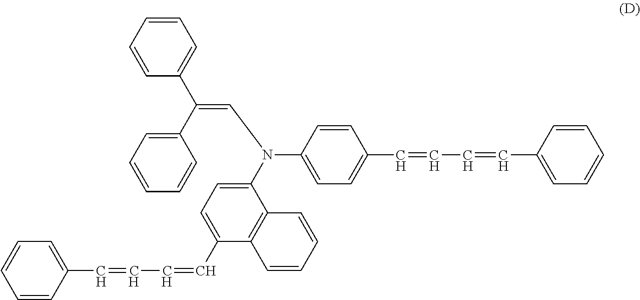

An electrophotographic photoconductor of Comparative Example 5 was produced in the same manner as in Example 1, except that Comparative Compound E represented by the following structural formula (E) was used instead of Compound 1 as a charge transport material.

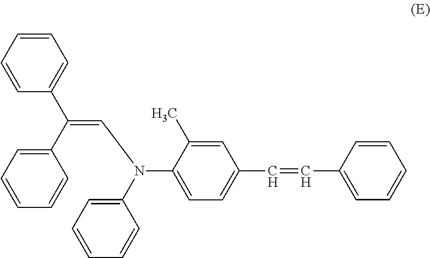

### Comparative Example 6

An electrophotographic photoconductor of Comparative Example 6 was produced in the same manner as in Example 1, except that Comparative Compound F represented by the following structural formula (F) was used instead of Compound 1 as a charge transport material.

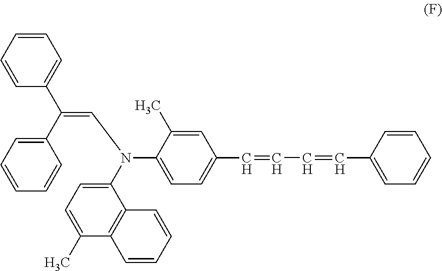

### Comparative Example 7

An electrophotographic photoconductor of Comparative Example 7 was produced in the same manner as in Example 1, except that Comparative Compound G represented by the following structural formula (G) was used instead of Compound 1 as a charge transport material.

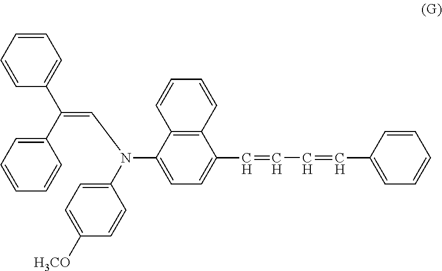

### Comparative Example 8

An electrophotographic photoconductor of Comparative Example 8 was produced in the same manner as in Example 1, except that Comparative Compound H represented by the following structural formula (H) was used instead of Compound 1 as a charge transport material.

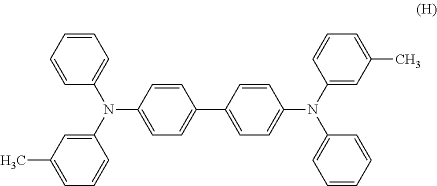

The photoconductors produced in Examples 1 to 10 and Comparative Examples 1 to 8 as described above were each evaluated for (a) gas resistance, (b) printing durability (abrasion resistance) and (c) stability in electric characteristics, and further overall judgment for (d) photoconductor performance was made as follows.

### (a) Gas Resistance

For evaluation in an actual machine, the photoconductors of Examples 1 to 10 and Comparative Examples 1 to 8 were each mounted in a commercially available copying machine (product name: MX-3100FG by Sharp Kabushiki kaisha) including a corona charger as means for charging each photoconductor, and 50000 recording paper sheets of actual copying of a test image having a predetermined pattern was performed with the copying machine under a normal temperature/low humidity (N/L) environment at a temperature of 25° C. and a relative humidity of 10%. The copying machine was deactivated for 1 hour after completion of the 50000-sheet actual copying, and then copying of a half tone image on a recording paper sheet was performed to obtain a first evaluation image. Subsequently, 50000 recording paper sheets of actual copying of a test image having a predetermined pattern under the N/L environment at a temperature of 25° C. and a relative humidity of 10% was performed again. The copying machine was deactivated for 12 hours after completion of the 50000-sheet actual copying, and then copying of a half tone image on a recording paper sheet was performed to obtain a second evaluation image.

The first evaluation image and the second evaluation image were each observed by visual observation to judge the image quality in a part of the recording paper corresponding to a part to which a toner image was transferred from a part of the photoconductor closest to the corona charger during the deactivation of the copying machine by the degree of image defects such as blank dots and black bars to obtain an evaluation index for ozone gas resistance.

The criteria of the image quality are as follows:

VG (very good): No image defect was observed both in the first evaluation image and the second evaluation image.

G (good): Some image defects were observed in one or both of the first evaluation image and the second evaluation image to a negligible extent.)

NB (not bad): Some image defects were observed in one or both of the first evaluation image and the second evaluation image to such an extent that there is no problem in practical use.

B (bad): Many image defects were observed in one or both of the first evaluation image and the second evaluation image to such an extent that the image is unusable.

### (b) Printing Durability

For evaluation in an actual machine, the photoconductors of Examples 1 to 10 and Comparative Examples 1 to 8 were each mounted in a commercially available copying machine (product name: MX-3100FG by Sharp Kabushiki kaisha) including a corona charger as means for charging each photoconductor, and 100000 recording paper sheets of actual copying of a test image having a predetermined pattern was performed with the copying machine under a normal temperature/normal humidity (N/N) environment at a temperature of 25° C. and a relative humidity of 50%. Thereafter, the photoconductor was taken out of the machine to be measured for a film thickness d1 [μm] of the photosensitive layer, and the value d1 is subtracted from a film thickness d0 of the originally prepared photosensitive layer to determine a difference (d0-d1) as a film wear amount Δd.

The criteria of the printing durability are as follows:

VG (very good): Δd is less than 5 μm.

G (good): Δd is 5 μm or more and less than 8 μm.

NB (not bad): Δd is 8 μm or more and less than 12 μm.

B (bad): Δd is 12 μm or more.

### (c) Electric Characteristics

For evaluation in an actual machine, the photoconductors of Examples 1 to 10 and Comparative Examples 1 to 8 were each mounted in a test copying machine to be evaluated for electric characteristics under a low temperature/low humidity (L/L) environment at a temperature of 5° C. and a relative humidity of 20%, and a high temperature/high humidity (H/H) environment at a temperature of 35° C. and a relative humidity of 85% as follows. As the test copying machine, used was a commercially available copying machine (product name: MX-3100FG by Sharp Kabushiki kaisha) including a corona charger as means for charging each photoconductor and provided therein with a surface potentiometer (product name: CATE751 by GEN-TECH, INC.) for measuring the surface potential of the photoconductor in the image formation process. The copying machine MX-3100FG is an image forming apparatus of a negative charge type, in which the photoconductor surface is negatively charged to perform an electrophotographic image forming process.

In the test copying machine, each of the photoconductors of Examples 1 to 10 and Comparative Examples 1 to 8 was measured for the surface potential immediately after the charge operation as a charge potential V0 (V) to determine the value as an initial charge potential V01. In addition, each photoconductor was measured for the surface potential immediately after the exposure to a laser beam as a residual potential Vr (V) to determine the value as an initial residual potential Vr1.

Subsequently, 300000 recording paper sheets of consecutive copying of a test image having a predetermined pattern was performed, and then the photoconductor was measured for the charge potential V0 and the residual potential Vr in the same manner as in the initial stage to determine the values as a charge potential V02 after repeated use and a residual potential Vr2 after repeated use. The absolute value of the difference between the initial charge potential V01 and the charge potential V02 after repeated use was determined as a charge potential change ΔV0(=|V01−V02 I). In addition, the absolute value of the difference between the initial residual potential Vr1 and the residual potential Vr2 after repeated use was determined as a residual potential change ΔVr(=|Vr1−Vr2|). The photoconductors were evaluated for electric characteristics according to the charge potential change ΔV0 and the residual potential change ΔVr as evaluation indices.

### Electric Characteristics Under L/L Environment

The criteria for the evaluation for the electric characteristics under the L/L environment are as follows:

VG (very good): ΔV0≦35 V and ΔVr≦55 V and Vr1≦100 V

G (good): ΔV0≦35 V and 55 V<ΔVr≦80 V and Vr1≦150 V; or 35 V<ΔV0≦75 V and ΔVr≦55V and Vr1≦150 V

NB (not bad; no problem for practical use): 35 V<ΔV0≦75 V and 55 V<ΔVr≦80 V and Vr1≦200 V

B (bad): ΔV0>75 V or ΔVr >80 V or Vr1>200 V

### Electric Characteristics Under H/H Environment

The criteria for the evaluation for the electric characteristics under the H/H environment are as follows:

VG (very good): ΔV0≦15 V and ΔVr≦105 V

G (good): ΔV0≦15 V and 105 V<ΔVr≦125 V; or 15 V<ΔV0≦35 V and ΔVr≦105V

NB (not bad; no problem for practical use): 15 V<ΔV0≦30 V and 105 V<ΔVr≦125V

B (bad): ΔV0>30 V or ΔVr>125 V

### Overall Judgment of Electric Characteristics

In addition, overall judgment of the electric characteristics was made based on the result of the evaluation under the L/L environment and the result of the evaluation under the H/H environment. The criteria for the overall judgment of the stability in the electric characteristics are as follows:

VG (very good): Very good (VG) both under the L/L environment and the H/H environment.

G (good): Good (G) under either one of the L/L environment and the H/H environment, and very good (VG) or good (G) under the other environment.

NB (not bad; no problem for practical use): No problem for practical use (NB) under either one of the L/L environment and the H/H environment and not evaluated as bad (B) under the other environment.

B (bad): Bad (B) under either one or both of the L/L environment and the H/H environment.

### (d) Overall Judgment of Photoconductor Performance

Overall judgment of the photoconductor performance was made based on the result of the evaluation for the gas resistance and the printing durability, and the overall judgment of the stability in the electric characteristics. The criteria for the overall judgment are as follows:

VG (very good): Very good (VG) all in gas resistance, printing durability and stability in electric characteristics.

G (good): Good (VG) in any one of gas resistance, printing durability and stability in electric characteristics, and very good (VG) or good (G) in the others.

NB (not bad; no problem for practical use): No problem for practical use (NB) in any one of gas resistance, printing durability and stability in electric characteristics, and not evaluated as bad (B) in the others.)

B (bad): Bad (B) in any one or all of gas resistance, printing durability and stability in electric characteristics.

Table 3 shows the evaluation results.

TABLE 3

| | | | | | Repeated electric characteristics | | | | | | | | | | |
|---|---|---|---|---|---|---|---|---|---|---|---|---|---|---|---|
| | | | Printing durability | | L/L | | | | | H/H | | | | | |
| | Charge | Gas | Wear | | potential characteristics | | | | | potential characteristics | | | | Overall | |
| | transport | resistance | amount | Evalua- | | | | | Evalu- | | | | Evalu- | evalua- | Overall |
| Example | material | evaluation | (Δd) | tion | Vo | Vr | ΔVo | ΔVr | ation | Vo | ΔVo | ΔVr | ation | tion | judgment |
| 1 | 1 | VG | 4.3 | VG | −572 | −85 | 20 | 40 | VG | −554 | 18 | 80 | VG | VG | VG |
| 2 | 4 | VG | 3.5 | VG | −575 | −95 | 25 | 41 | VG | −557 | 15 | 75 | VG | VG | VG |
| 3 | 7 | VG | 4.7 | VG | −576 | −90 | 24 | 43 | VG | −558 | 15 | 82 | VG | VG | VG |
| 4 | 10 | VG | 4.1 | VG | −573 | −88 | 23 | 38 | VG | −553 | 18 | 77 | VG | VG | VG |
| 5 | 15 | VG | 3.6 | VG | −576 | −78 | 28 | 41 | VG | −558 | 17 | 78 | VG | VG | VG |
| 6 | 18 | VG | 4.1 | VG | −579 | −78 | 26 | 40 | VG | −552 | 16 | 90 | VG | VG | VG |
| 7 | 20 | VG | 4.3 | VG | −574 | −82 | 25 | 35 | VG | −548 | 15 | 77 | VG | VG | VG |
| 8 | 23 | VG | 3.9 | VG | −575 | −90 | 25 | 40 | VG | −548 | 18 | 85 | VG | VG | VG |
| 9 | 32 | VG | 3.6 | VG | −575 | −90 | 26 | 35 | VG | −555 | 20 | 75 | VG | VG | VG |
| 10 | 36 | VG | 4.0 | VG | −577 | −79 | 28 | 42 | VG | −552 | 15 | 81 | VG | VG | VG |
| Compar- | A | B | 7.2 | G | −572 | −75 | 21 | 38 | VG | −554 | 15 | 75 | VG | VG | B |
| ative 1 | | | | | | | | | | | | | | | |
| Compar- | B | B | 6.3 | G | −576 | −68 | 25 | 35 | VG | −558 | 18 | 68 | VG | VG | |
| ative 2 | | | | | | | | | | | | | | | |
| Compar- | C | B | 6.5 | G | −575 | −81 | 25 | 33 | VG | −555 | 18 | 67 | VG | VG | B |
| ative 3 | | | | | | | | | | | | | | | |
| Compar- | D | B | 6.9 | G | −577 | −68 | 23 | 38 | VG | −552 | 15 | 69 | VG | VG | B |
| ative 4 | | | | | | | | | | | | | | | |
| Compar- | E | VG | 5.7 | G | −576 | −221 | 25 | 55 | B | −552 | −147 | 75 | VG | B | B |
| ative 5 | | | | | | | | | | | | | | | |
| Compar- | F | VG | 5.1 | G | −577 | −208 | 23 | 52 | B | −553 | −128 | 79 | VG | B | B |
| ative 6 | | | | | | | | | | | | | | | |
| Compar- | G | NB | 8.8 | NB | −576 | −95 | 20 | 50 | VG | −556 | 18 | 85 | VG | VG | NB |
| ative 7 | | | | | | | | | | | | | | | |
| Compar- | H | B | 15.8 | G | −578 | −75 | 26 | 42 | VG | −547 | 10 | 70 | VG | VG | B |
| ative 8 | | | | | | | | | | | | | | | |

Comparison between Examples 1 to 10 and Comparative Examples 1 to 8 has revealed that the photoconductors of Examples 1 to 10 containing an enamine compound according to the present invention have superior gas resistance, abrasion resistance and electric characteristics, and maintain better electric characteristics even after repeated use, compared with the photoconductors of Comparative Examples 1 to 8 not containing such a compound.

### INDUSTRIAL APPLICABILITY

It is possible to provide a photoconductor having enhanced gas resistance, high sensitivity and sufficient photoresponsivity by including an enamine compound of the present invention in the photosensitive layer as the charge transport material.

Having the enhanced gas resistance, in addition, the photoconductor of the present invention can provide high-quality images even when used in a high-speed electrophotographic process.

1. An electrophotographic photoconductor, comprising:
a conductive support; and
a photosensitive layer provided on the conductive support and containing a charge generation material and a charge transport material,
the photosensitive layer containing, as the charge transport material, a compound represented by the following general formula (I): 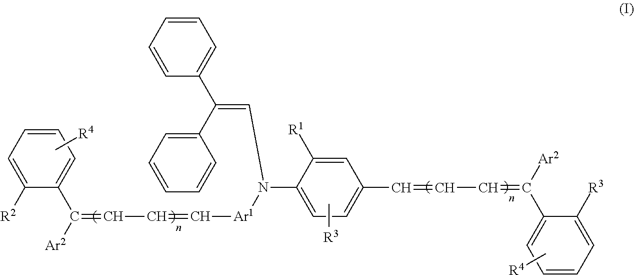
wherein Ar¹ represents an optionally substituted arylene or bivalent heterocyclic group; Ar²s, which may be the same or different, each represent a hydrogen atom or an optionally substituted alkyl, aralkyl, aryl or monovalent heterocyclic group; R¹ represents an optionally substituted alkyl group; R²s each represent a hydrogen atom or an optionally substituted alkyl group; R³ and R⁴s, which may be the same or different, each represent a hydrogen atom or an optionally substituted alkyl or alkoxy group; and n is 0 or 1.

2. The electrophotographic photoconductor according to claim 1, wherein in the general formula (I), Ar¹ represents an arylene group selected from the group consisting of phenylene, naphthylene, biphenylene, fluorenylene and stilbenzylene that may be substituted with a linear or branched C₁₋₄ alkyl, alkoxy or alkylene group or a phenoxy or phenylthio group that may be substituted with one or more halogen atoms or a linear or branched C₁₋₄ alkyl or alkoxy group; or a bivalent heterocyclic group selected from the group consisting of furylene, thienylene, thiazolylene, benzofurylene, phenylbenzofurylene and carbazolylene that may be substituted with a linear or branched C₁₋₄ alkyl, alkoxy or alkylene group or a phenoxy or phenylthio group that may be substituted with one or more halogen atoms or a linear or branched C₁₋₄ alkyl or alkoxy group,
Ar²s, which may be the same or different, each represent a hydrogen atom, an alkyl group selected from the group consisting of methyl, ethyl, n-propyl, isopropyl, t-butyl, cyclohexyl and cyclopentyl groups that may be substituted with a linear or branched C₁₋₄ alkyl or alkoxy group or a phenyl, phenoxy, phenylthio or naphthyl group that may be substituted with one or more halogen atoms or a linear or branched C₁₋₄ alkyl or alkoxy group; and aralkyl group selected from the group consisting of benzyl and phenethyl groups that may be substituted with a linear or branched C₁₋₄ alkyl or alkoxy group or a phenyl, phenoxy, phenylthio or naphthyl group that may be substituted with one or more halogen atoms or a linear or branched C₁₋₄ alkyl or alkoxy group; or a monovalent heterocyclic group selected from the group consisting of furyl, thienyl, thiazolyl, benzofuryl, benzothiophenyl and benzothiazolyl groups,
R¹ represents an alkyl group selected from the group consisting of methyl, ethyl, n-propyl, isopropyl, n-butyl and t-butyl groups that may be substituted with a halogen atom, R²s, which may be the same or different, each represent a hydrogen atom or an alkyl group selected from the group consisting of methyl, ethyl, n-propyl, isopropyl, n-butyl and t-butyl groups that may be substituted with a halogen atom,
R³ represents a hydrogen atom; or an alkyl group selected from the group consisting of methyl, ethyl, n-propyl, isopropyl, n-butyl and t-butyl groups that may be substituted with a halogen atom, and R⁴s each represent a hydrogen atom; an alkyl group selected from the group consisting of methyl, ethyl, n-propyl, isopropyl, n-butyl and t-butyl groups that may be substituted with a halogen atom; or an alkoxy group selected from the group consisting of methoxy, ethoxy, n-propoxy, isopropoxy, n-butoxy and t-butoxy groups that may be substituted with a halogen atom.

3. The electrophotographic photoconductor according to claim 1, wherein in the general formula (I), Ar¹ represents an arylene group selected from the group consisting of phenylene and naphthylene that may be substituted with one or more halogen atoms or a linear or branched C₁₋₄ alkyl, alkoxy or alkylene group,
Ar²s, which may be the same or different, each represents a hydrogen atom; an alkyl group selected from the group consisting of methyl, ethyl, n-propyl, isopropyl and t-butyl groups that may be substituted with one or more halogen atoms, a linear or branched C₁₋₄ alkyl or alkoxy group or a phenyl, phenoxy or naphthyl group; or a monovalent heterocyclic group selected from the group consisting of furyl, thienyl and thiazolyl groups that may be substituted with one or more halogen atoms, a linear or branched C₁₋₄ alkyl or alkoxy group or a phenyl, phenoxy or naphthyl group, R¹ represents an alkyl group selected from the group consisting of methyl, ethyl, n-propyl, isopropyl, n-butyl and t-butyl groups, R²s, which may be the same or different, each represent a hydrogen atom or an alkyl group selected from the group consisting of methyl, ethyl, n-propyl, isopropyl, n-butyl and t-butyl groups,
R³ R represents a hydrogen atom or an alkyl group selected from the group consisting of methyl, ethyl, n-propyl, isopropyl, n-butyl and t-butyl groups, and
R⁴s each represent a hydrogen atom or a group selected from the group consisting of methyl, ethyl, methoxy and ethoxy groups.

4. The electrophotographic photoconductor according to claim 1, wherein the general formula (I), Ar¹ represents a group selected from the group consisting of 1,4-phenylene, 2-methyl-1,4-phenylene, 5,6,7,8-tetrahydro-1,4-naphthylene and 1,4-naphthylene groups,
Ar²s, which may be the same or different, each represent a hydrogen atom; or a group selected from the group consisting of isopropyl, phenyl, benzyl and thienyl groups,
R²s, which may be the same or different, each represent a hydrogen atom, or a methyl or ethyl group,
R³ represents a hydrogen atom or methyl group, and
R⁴s each represent a hydrogen atom or an o-methyl, p-methyl or p-methoxy group.

5. The electrophotographic photoconductor according to claim 1, wherein the photosensitive layer contains, as the charge generation material, an oxotitaniumphthalocyanine having at least a diffraction peak in a diffraction spectrum with Cu-Kα a characteristic X-rays (wavelength: 1.54 Å) at a Bragg angle (2θ±0.2°) of 27.2°.

6. The electrophotographic photoconductor according to claim 1, wherein the photosensitive layer is a multilayer photosensitive layer including a charge generation layer containing the charge generation material and a charge transport layer containing the charge transport material.

7. The eletrophotographic photoconductor according to claim 1, wherein the photosensitive layer is a monolayer photosensitive layer containing the charge generation material and the charge transport material.

8. The electrophotographic photoconductor according to claim 1, further comprising an interlayer between the conductive support and the photosensitive layer.

9. An image forming apparatus, comprising:
the electrophotographic photoconductor according to claim 1;
charge means for charging the electrophotographic photoconductor;
exposure means for exposing the electrophotographic photoconductor to form an electrostatic latent image;
development means for developing the electrostatic latent image into a toner image;
transfer means for transferring the toner image onto a medium; and
fixing means for fixing the toner image onto the medium.

10. The image forming apparatus according to claim 9, wherein an image is formed by using a reverse development process.
